(19) United States
(12) Patent Application Publication
(10) Pub. No.: US 2013/0015204 A1
(43) Pub. Date: Jan. 17, 2013

(54) SINGLE-USE CONTAINERS AND USES THEREOF

(71) Applicant: Arash Gol, Wakerley (AU)

(72) Inventor: Arash Gol, Wakerley (AU)

(21) Appl. No.: 13/518,528

(22) PCT Filed: Dec. 24, 2010
(86) PCT No.: PCT/AU2010/001752

§ 371 Date: Sep. 13, 2012

Related U.S. Application Data
(60) Provisional application No. 61/290,035, filed on Dec. 24, 2009.

(30) Foreign Application Priority Data
Dec. 24, 2009 (AU) 2009906236

(51) Int. Cl. B67D 7/74; B67D 7/00; B65D 85/00; B65D 21/024; B65D 47/10

(52) U.S. Cl. 222/129; 206/438; 206/459.5; 222/541.6

(57) ABSTRACT

This invention relates generally to improving compliance. More specifically, the invention relates to single-use containers containing liquid formulations for ingestion, strips and packages of such containers, and to compliance improving systems using such containers.

### FIELD OF THE INVENTION

This invention relates generally to improving compliance. More specifically, the invention relates to single-use containers containing liquid formulations for ingestion, strips and packages of such containers, and to compliance improving systems using such containers.

### BACKGROUND OF THE INVENTION

The degree to which a person correctly follows the programme or instructions for taking their medicinal or nutritional supplements is called compliance. Generally speaking, medicinal or nutritional compliance throughout society is poor. The World Health Organisation in a 2003 report described patient non-compliance as a “worldwide problem of striking magnitude”. Poor compliance can adversely affect the person's health and costs the healthcare system a significant amount each year.

The British National Formulary lists a number of reasons for poor compliance including forgetfulness, unclear administration instructions, complicated regimens, physical difficulty in complying (e.g. opening medicine containers, handling small tablets, swallowing difficulties), side-effects (including those not caused by the active agent, but by other components of the supplement), and unattractive formulation (e.g. unpleasant taste). Compliance is observed throughout all groups of society, including the elderly (particularly with regards to forgetfulness, unclear administration instructions, complicated regimens, and physical difficulty in complying) and children (particularly with regards to unattractive formulations, and especially with regards to the taste of the formulation).

A number of products and systems have been developed with the aim of enhancing patient compliance. For example, tablets often have flavouring agents added to the formulation or are coated with a layer that includes flavouring agents to mask objectionable flavours or odours, protect unstable tablet compositions and improve the appearance of the tablet. U.S. Pat. No. 5,098,715 for example, describes one such tablet coating that “provides a perception of said flavour for at least five seconds after oral administration [of the tablet]”.

Packaging has been used to enhance compliance. U.S. patent application 2007/0187281 describes a system that creates customised packaging for a particular patient based on their particular medications (both prescribed and over-the-counter medications and nutritional supplements) and regimes for taking these medications. The customised packaging contains all the patient's medications in one package organised by administration timepoint (e.g. Monday to Friday on one axis and Breakfast, Lunch, Dinner and Bed Time on the other). The system is described as improving “ease of use” in order to improve patient compliance.

U.S. patent application 2008/0190801 describes a packaging system comprising a blister package of medication along with a retainingdevice that supports the blister package in a vertical orientation which allows for a “visually prominent display” which “is intended to provide the patient with a visual cue that will serve to remind him or her of the need to comply with the prescribed dosing regime associated with the medication, and thus reduce the incidence of non-compliance”.

More elaborate measures have been proposed in order to improve compliance. U.S. Pat. No. 5,014,798, for example, describes a medicine bottle with a cap that weighs the medicine bottle from time to time and compares the actual weight with the “compliance required” weight, with a visual display on the cap that displays the compliance results. The patent also describes an optional audio assist that may direct the patient to “call the doctor” if a significant compliance deviation is recognised.

U.S. Pat. No. 7,584,108 describes a system that controls a patient's access to an entertainment programme to encourage their compliance with a treatment plan, by collecting compliance data from the patient and comparing this data to evaluation criteria to determine if the patient is in compliance with the treatment plan. If the patient is in compliance, access is granted to the entertainment plan, but if not then access is restricted. Optionally the patient's compliance data may also be transmitted to their healthcare provider.

In the course of research into patient compliance, the present inventor has discovered that a key factor in improving compliance is to remove factors of the system that contribute to non-compliance, instead of attempting to mask such factors or making a more complicated system. Thus the present inventor discovered and developed single-use containers of liquid formulations, strips and packages of these containers as well as and systems of using these containers that also assist in improving compliance.

### SUMMARY OF THE INVENTION

Accordingly, the present invention provides a single-use container comprising a reservoir for holding a sterile liquid formulation, wherein the reservoir is in fluid communication with an outlet adapted to be opened in order to dispense the formulation in an aseptic manner, wherein the formulation is formulated for ingestion, and wherein the formulation consists essentially of a medicinal supplement and/or a nutritional supplement.

In some embodiments, the formulation is substantially free of any flavouring agent selected from the group consisting of sucrose, glucose, fructose, galactose, lactose, glutamic acid, monosodium L-glutamate, monopotassium L-glutamate, calcium di-L-glutamate, monoammonium L-glutamate, magnesium di-L-glutamate, guanylic acid, disodium guanylate, dipotassium guanylate, calcium guanylate, inosinic acid, disodium inosinate, dipotassium inosinate, calcium inosinate, calcium 5′-ribonucleotides, disodium 5-ribonucleotide, sodium 5-ribonucleotide, maltol, and ethyl maltol.

In some embodiments the formulation is substantially free of any preservative selected from the group consisting of ammonia, benzoic acid, sodium benzoate, potassium benzoate, calcium benzoate, ethyl para-hydroxybenzoate, sodium ethyl para-hydroxybenzoate, propylparaben, sodium propyl para-hydroxybenzoate, methylparaben, sodium methyl p-hydroxybenzoate, sulphur dioxide, sodium sulphite, sodium bisulphite, sodium metabisulphite, potassium metabisulphite, potassium sulphite, calcium sulphite, calcium hydrogen sulphite, potassium bisulphite, biphenyl, orthophenyl phenol, sodium orthophenyl phenol, thiabendazole, nisin, natamycin, formic acid, sodium formate, calcium formate, hexamethylene tetramine, formaldehyde, dimethyl dicarbonate, potassium nitrite, sodium nitrite, sodium nitrate, potassium nitrate, acetic acid, potassium acetate, sodium acetate, sodium diacetate, calcium acetate, ammonium acetate, lactic acid, propionic acid, sodium propionate, calcium propionate, potassium propionate, boric acid, sodium tetraborate, carbon dioxide, lysozyme, and EDTA.

In some embodiments of these aspects, the formulation consists essentially of a vitamin and/or a mineral and/or a herbal extract.

The formulation may comprise a bitter-tasting vitamin.

The formulation may be formulated for addition to a food or beverage prior to ingestion, including a bitter food or bitter beverage. In some embodiments, the formulation is formulated for addition to a hot food or hot beverage.

The container of the above aspects may suitably comprise a frangible means located between the reservoir of the container and the outlet of the container, that permits opening of the container in order to dispense the formulation. Alternatively, the outlet comprises a cap or lid that permits opening of the container in order to dispense the formulation.

In some embodiments the reservoir holds a predetermined volume of formulation. In some embodiments the container dispenses a predetermined volume of formulation.

In some embodiments the reservoir holds a unit dosage of formulation. In other embodiments the container dispenses a unit dosage of formulation.

In some embodiments the container maintains a sterile environment for the liquid before dispensing.

The container may be produced by the “blow-fill-seal” process.

In some embodiments the container is labeled to indicate that the container is to be used at a particular time. The container may be labeled at an end of the container, or otherwise, and may be labeled by engraving, embossed text, graduations in the mold, or by attachment of a label to the surface of the container.

In another aspect the present invention provides a package comprising single-use containers of the present invention. In some embodiments, the package comprises labeled single-use containers. Each container within the package may be labeled with the same label, or with a different label, or the package may comprise some containers labeled with the same label and some containers labeled with different labels.

In a further aspect the present invention provides a strip of single-use containers of the present invention connected to each other by attaching portions of adjacent containers to form a connected strip. The containers may be detachably connected. The strip or each container may be labeled to indicate when the containers are to be used. A packages of these strips is also contemplated by the present invention. The package strip may be labeled to indicate when the containers are to be used.

In yet another aspect the present invention provides a strip of single-use containers, the containers each comprising a reservoir for holding a sterile liquid formulation, wherein each reservoir is in fluid communication with an outlet of each container adapted to be opened in order to dispense the formulation it holds in an aseptic manner, wherein each formulation is formulated for ingestion, wherein the containers are connected by attaching portions of adjacent containers to form a connected strip, wherein the strip or each container in the strip is labeled to indicate when the containers are to be used. The containers in the strip may be detachably connected.

In some embodiments an end of each container in the strip is labeled. The strip or each container in the strip may be labeled by engraving, embossed text, graduations in the mold, or by attachment of a label to the surface of the container.

In some embodiments, the formulation in each container is substantially free of any flavouring agent selected from the group consisting of sucrose, glucose, fructose, galactose, lactose, glutamic acid, monosodium L-glutamate, monopotassium L-glutamate, calcium di-L-glutamate, monoammonium L-glutamate, magnesium di-L-glutamate, guanylic acid, disodium guanylate, dipotassium guanylate, calcium guanylate, inosinic acid, disodium inosinate, dipotassium inosinate, calcium inosinate, calcium 5′-ribonucleotides, disodium 5-ribonucleotide, sodium 5-ribonucleotide, maltol, and ethyl maltol.

In some embodiments, the formulation in each container is substantially free of any preservative selected from the group consisting of ammonia, benzoic acid, sodium benzoate, potassium benzoate, calcium benzoate, ethyl para-hydroxybenzoate, sodium ethyl para-hydroxybenzoate, propylparaben, sodium propyl para-hydroxybenzoate, methylparaben, sodium methyl p-hydroxybenzoate, sulphur dioxide, sodium sulphite, sodium bisulphite, sodium metabisulphite, potassium metabisulphite, potassium sulphite, calcium sulphite, calcium hydrogen sulphite, potassium bisulphite, biphenyl, orthophenyl phenol, sodium orthophenyl phenol, thiabendazole, nisin, natamycin, formic acid, sodium formate, calcium formate, hexamethylene tetramine, formaldehyde, dimethyl dicarbonate, potassium nitrite, sodium nitrite, sodium nitrate, potassium nitrate, acetic acid, potassium acetate, sodium acetate, sodium diacetate, calcium acetate, ammonium acetate, lactic acid, propionic acid, sodium propionate, calcium propionate, potassium propionate, boric acid, sodium tetraborate, carbon dioxide, lysozyme, and EDTA. The formulation may consist essentially of a medicinal supplement and/or a nutritional supplement. In other embodiments, the formulation consists essentially of a vitamin and/or a mineral and/or a herbal extract. The formulation may comprise a bitter-tasting vitamin.

In some embodiments, the formulation is formulated for addition to a food or beverage prior to ingestion, including a bitter food or bitter beverage. In some embodiments, the formulation is formulated for addition to a hot food or hot beverage.

The containers of the strip may suitably comprise a frangible means located between the reservoir of the container and the outlet of the container, that permits opening of each container in order to dispense the formulation. Alternatively, the outlet comprises a cap or lid that permits opening of the container in order to dispense the formulation.

In some embodiments the reservoir of each container of the strip holds a predetermined volume of formulation. In some embodiments the container dispenses a predetermined volume of formulation. In some embodiments the reservoir of each container of the strip holds a unit dosage of formulation. In some embodiments the container dispenses a unit dosage of formulation.

In some embodiments the container maintains a sterile environment for the liquid before dispensing.

The container may be produced by the “blow-fill-seal” process.

The present invention also contemplates packages containing the strip of the present invention.

The present invention also provides a compliance enhancing system comprising the package or strip of the present invention, wherein the package or strip is labeled to indicate that the formulation of each container is to be ingested in conjunction with an existing routine. The package or strip may be labeled to indicate that the formulation within the container is to be dispensed into a food or beverage that is taken as part of the existing routine. The existing routine may be a daily routine, including but not limited to taking a coffee each morning.

The present invention also provides a method of enhancing compliance in a consumer, the method comprising providing a consumer with a single-use container of the present invention, wherein the container is labeled to indicate that the formulation within the container is to be dispensed into a food or beverage that is taken as part of an existing routine, the consumer dispensing the formulation into a food or beverage that is taken as part of the existing routine, the consumer then ingesting the food or beverage containing the formulation.

### BRIEF DESCRIPTION OF THE DRAWINGS

FIG. 1 is an elevational view of five different illustrative embodiments of the single-use container of the present invention.

FIG. 2 is an elevational view of three different illustrative embodiments of strips of containers of the present invention.

FIG. 3 is a perspective view of an illustrative embodiment of a strip of containers of the present invention.

FIG. 4 is a perspective view of an illustrative embodiment of a package of the present invention.

### DETAILED DESCRIPTION OF THE INVENTION

### 1. Definitions

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

The articles “a” and “an” are used herein to refer to one or to more than one (i.e. to at least one) of the grammatical object of the article. By way of example, “an element” means one element or more than one, element.

The terms “aseptic” and “sterile” are used interchangeably herein to refer to formulations, containers, or other products that are substantially free from pathogens including bacteria, viruses, fungi, and parasites. Sterility may be achieved by any method known in the art, including but not limited to, using filtration (e.g., micron filtration) or radiation treatment.

Throughout this specification, unless the context requires otherwise, the words “comprise”, “comprises” and “comprising” will be understood to imply the inclusion of a stated step or element or group of steps or elements but not the exclusion of any other step or element or group of steps or elements. Thus, use of the term “comprising” and the like indicates that the listed elements are required or mandatory, but that other elements are optional and may or may not be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. For example, where a formulation “consists essentially of” a medicinal supplement and/or a nutritional supplement, this formulation would exclude any preservative or flavouring agent that is not a medicinal supplement or a nutritional supplement. By “consisting of” is meant including, and limited to, whatever follows the phrase “consisting of”. Thus, the phrase “consisting of” indicates that the listed elements are required or mandatory, and that no other elements may be present.

The term “ingestion” as used herein means taken into the stomach or alimentary canal.

The terms “patient”, “individual”, and “consumer” are used interchangeably herein to refer to any subject for whom ingestion of a liquid formulation as described herein is intended. The subject may be a human in need of treatment or prophylaxis for a condition or disease However, it will be understood that the aforementioned terms do not imply that symptoms are present.

The term “predetermined volume” as used herein refers to a volume that does not deviate by more than about 10%, 9%, 8%, 7%, 6%, 5%, 4%, 3%, 2%, 1%, 0.9%, 0.5%, 0.1% or 0.01% from the predetermined volume.

As used herein, the term “unit dose” or “unit dosage” refers to a discrete volume of formulation suitable as unitary dosages for ingestion by an individual, each unit containing a predetermined quantity of active material. Each unit dose may be calculated to produce a beneficial effect in the individual when ingested individually, or each unit dosage may be calculated to produce a beneficial effect in the individual when ingested more than one unit dosage are ingested either together or over a period of time.

### 2. Single-use Containers

The present invention is based on the discovery that a key factor in improving compliance is to remove factors of the system that contribute to non-compliance, instead of attempting to mask such factors or making a more complicated system. It was envisaged that creating a link in the consumer or patient's mind between an existing routine that they already carry out and taking their medicinal or nutritional supplements would be likely to improve compliance, as it would prevent the consumer with the perception that they have been loaded with another ‘task’ to perform regularly. In other words, it is believed that if the existing routine is already performed by the consumer then compliance would be less of an issue, as the consumer does not have to remember another ‘task’ to perform on a regular basis. It was particularly noted that linking an existing routine involving a food or a beverage to taking a medicinal or nutritional supplement, both of which are ingested, could be particularly beneficial, especially where the medicinal or nutritional supplement could be added to the food or beverage with little or no change to the perceived aroma or taste of the food or beverage, for example by use of sterile formulations maintained in an aseptic environment prior to use so that preservatives and flavouring agents were not required, or by addition to a food or a beverage with a smell and/or taste that could mask the smell and/or taste of the formulation. Thus the present inventor discovered and developed single-use containers of liquid formulations. It is envisaged that such containers will be readily used by the consumer in conjunction with existing routines involving food and beverage, including adding the liquid formulation to the food or beverage, thus increasing their compliance in taking particular formulations.

The single-use containers of the present invention may be any suitable container comprising a reservoir capable of holding a sterile liquid formulation, wherein the reservoir is in fluid communication with an outlet adapted to be opened in order to dispense the formulation in an aseptic manner, and wherein the formulation is formulated for ingestion, and wherein the formulation consists essentially of a medicinal supplement and/or a nutritional supplement.

The containers may be constructed of any suitable material, including plastic or glass. In specific embodiments the containers are constructed of a plastic material selected from the group consisting of polyethylene, polypropylene and polyvinyl chloride. Suitably the plastic material may be selected from low density polyethylene or high density polyethylene.

In specific embodiments, the reservoirs are capable of holding 0.1 mL, 0.2 mL, 0.3 mL, 0.5 mL, 1.0 mL, 2.5 mL, or 5.0 mL volume of liquid formulation, and any volume therebetween.

The container may be constructed so that the reservoir holds a predetermined volume or a unit dosage of formulation. The container may also be constructed so that it dispenses a predetermined volume or a unit dosage of formulation. These features may assist in enabling the formulation to be provided at a desired dosage to the consumer. In some embodiments, this is achieved by providing a container with a reservoir that holds a predetermined volume or a unit dosage of formulation, where the container dispenses substantially all the formulation from within the reservoir. When both the reservoir holds a first predetermined volume or a unit dosage of formulation, and the container is constructed so that it dispenses a second predetermined volume or a unit dosage of formulation, it is not necessary that the first predetermined volume and the second predetermined volume are the same volume.

The container is adapted to dispense the formulation in an aseptic manner. The “single-use” element of the containers of the present invention helps to achieve this feature so that once the formulation is dispensed from the container, the container is discarded. A second container may then be used for the next time the consumer desires to take the formulation, and a third container may then be used for the subsequent time the consumer desires to take the formulation, and so on. Such a feature can be contrasted with products currently on the market such as multiple use containers, where part of the total volume of the formulation held in the container is dispensed at one time, and the container stored to permit dispensing of further formulation from the same container at a later time,. for example containers with re-sealable lids, or with dispensing mechanisms such as pump attachments. Such multiple use containers may not maintain a sterile environment for the formulation, and/or may not dispense the formulation in an aseptic manner as once a first volume of formulation has been dispensed, the container including the dispensing mechanism is exposed to the environment, resulting in a risk of contamination for any subsequent dispensing of formulation. Often, the formulation held in such containers require the addition of preservatives in order to maintain sterility or avoid contamination with viruses, bacteria, fungi and the like.

In specific embodiments, the container may be constructed with a frangible means between the reservoir of the container and the outlet of the container that permits opening of container in order to dispense the formulation without the need for human hands to touch the formulation during or after it is dispensed, and thus assists in dispensing the formulation in an aseptic manner. In some embodiments, the container is a squeezable plastic container with a frangible means between the reservoir of the container and the outlet of the container, wherein the outlet of the container can be twisted at the site of the frangible means to open the container and permit dispensing of the liquid formulation. In specific embodiments, the container is constructed where the reservoir of the container is low density polyethylene, and the outlet of the container is high density polyethylene, so that frangible means between the reservoir of the container and the outlet of the container is easily twisted off. In some specific embodiments, the container is constructed where the reservoir of the container is an “accordion-like” structure so that the reservoir can be readily squeezed to permit dispensing of the formulation. In some specific embodiments, the container is constructed so that the volume that can be held by the reservoir is greater than the volume of the formulation. These embodiments mean that the reservoir will contain the formulation and also additional space (e.g. containing air or inert gas), which assists in dispensing the formulation.

Alternatively, the outlet comprises a cap or lid that permits opening of the container in order to dispense the formulation. In some embodiments, the container is a squeezable plastic container, wherein the outlet comprises a valve, and wherein the container can be squeezed, to permit the valve to open, and permit dispensing of the liquid formulation.

The container may also be constructed so as to maintain a sterile environment for the liquid formulation before the container is opened and the formulation dispensed. Many suitable methods to construct suitable containers are known in the art. The sterile environment may be achieved by filling the containers under vacuum, or without the presence of oxygen (for example using an inert gas such as nitrogen gas). In some embodiments, the containers are produced by the “blow-fill-seal” process, in which the containers are mechanically blow molded, filled with formulation, and then sealed in a continuous operation. The “blow-fill-seal” process ensures the formulation is held within a sterile environment. In some other embodiments, the containers are produced using a thermal heat packaging method.

The container may be constructed so as to reduce the opportunity for degradation of the liquid formulation. In some embodiments, the containers may be filled under vacuum, or without the presence of oxygen (for example using an inert gas such as nitrogen gas) to remove or eliminate the presence of oxygen and thus reduce oxidation. In some embodiments, the container may be covered with a material, for example with a pouch, or constructed from suitable material, such that light is blocked from reaching the formulation within the container. In exemplary embodiments, the container may be covered with an pouch constructed of aluminium.

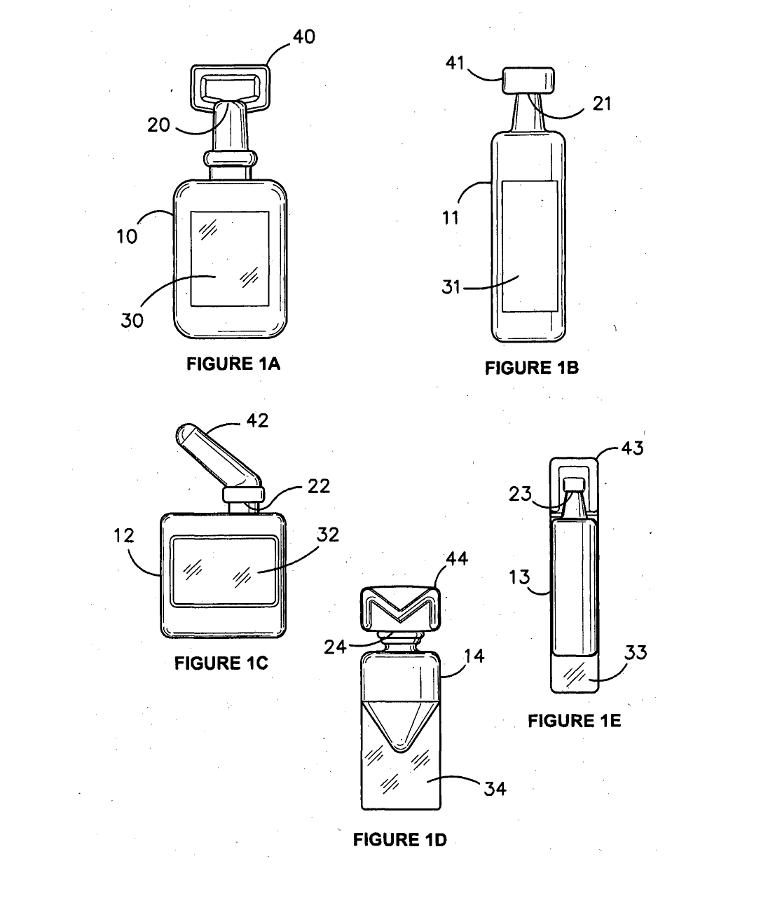

Examples of suitable containers for use in the present invention are shown in FIG. 1, which shows an elevational view of five different illustrative embodiments of the single-use container of the present invention, indicated by FIG. 1A, FIG. 1B, FIG. 1C, FIG. 1D and FIG. 1E. In each Figure, the reservoir of each container is indicated with 10, 11, 12, 13 and 14; the outlet comprising a cap or lid is indicated with 40, 41, 42, 43, and 44; the opening of the outlet (which permits dispensing of the formulation once the cap or lid has been removed) is indicated with 20, 21, 22, 23 and 24; and 30, 31, 32, 33, 34 indicate suitable locations for labeling containers if labeled in accordance with some embodiments of the present invention.

Further examples of suitable containers for use in the present invention are disclosed in U.S. Pat. No. 3,356,244, U.S. Pat. No. 3,862,684, U.S. Pat. No. 3,913,734, U.S. Pat. No. 3,930,500, U.S. Pat. No. 3,993,223, U.S. Pat. No. 5,409,125, U.S. Pat. No. 6,241,124, U.S. 2005-0145648, the contents of each is incorporated herein by reference.

### 3. Strips of Containers

The present invention also provides strips of single-use containers connected to each other by attaching portions of adjacent containers to form a connected strip, wherein each single-use container comprises a reservoir for holding a sterile liquid formulation, wherein the reservoir is in fluid communication with an outlet adapted to be opened in order to dispense the formulation it holds in an aseptic manner, wherein the formulation is formulated for ingestion, and wherein the formulation consists essentially of a medicinal supplement and/or a nutritional supplement.

In some embodiments the formulation in each container is substantially free of any flavouring agent selected from the group consisting of sucrose, glucose, fructose, galactose, lactose, glutamic acid, monosodium L-glutamate, monopotassium L-glutamate, calcium di-L-glutamate, monoammonium L-glutamate, magnesium di-L-glutamate, guanylic acid, disodium guanylate, dipotassium guanylate, calcium guanylate, inosinic acid, disodium inosinate, dipotassium inosinate, calcium inosinate, calcium 5′-ribonucleotides, disodium 5-ribonucleotide, sodium 5-ribonucleotide, maltol, and ethyl maltol.

In some embodiments the formulation in each container is substantially free of any preservative selected from the group consisting of ammonia, benzoic acid, sodium benzoate, potassium benzoate, calcium benzoate, ethyl para-hydroxybenzoate, sodium ethyl para-hydroxybenzoate, propylparaben, sodium propyl para-hydroxybenzoate, methylparaben, sodium methyl p-hydroxybenzoate, sulphur dioxide, sodium sulphite, sodium bisulphite, sodium metabisulphite, potassium metabisulphite, potassium sulphite, calcium sulphite, calcium hydrogen sulphite, potassium bisulphite, biphenyl, orthophenyl phenol, sodium orthophenyl phenol, thiabendazole, nisin, natamycin, formic acid, sodium formate, calcium formate, hexamethylene tetramine, formaldehyde, dimethyl dicarbonate, potassium nitrite, sodium nitrite, sodium nitrate, potassium nitrate, acetic acid, potassium acetate, sodium acetate, sodium diacetate, calcium acetate, ammonium acetate, lactic acid, propionic acid, sodium propionate, calcium propionate, potassium propionate, boric acid, sodium tetraborate, carbon dioxide, lysozyme, and EDTA.

The present invention further provides strips of single-use containers, the containers each comprising a reservoir for holding a sterile liquid formulation, wherein each reservoir is in fluid communication with an outlet of each container adapted to be opened in order to dispense the formulation it holds in an aseptic manner, wherein the formulation in each container is formulated for ingestion, wherein the containers are connected by attaching portions of adjacent containers to form a connected strip, wherein the strip or each container in the strip is labeled to indicate when the containers are to be used.

The portions of adjacent containers that are connected to each other may comprise part of the outlet of each container, or the reservoir portion of each container, or both the outlet and the reservoir portion of each container.

In specific embodiments, the containers are detachably connected to each other.

Suitable strips of the present invention include a row of containers connected to each other, where each container is connected to two other containers; with the exception of the two containers at each end of the row that are connected to only one container. Other suitable strips of the present invention include lattices of containers connected to each other, where each container is connected to four other containers, with the exception of the containers on the outside of the lattice which are either connected to two other containers if on a corner of the lattice or are connected to three other containers if on the outside edge of the lattice.

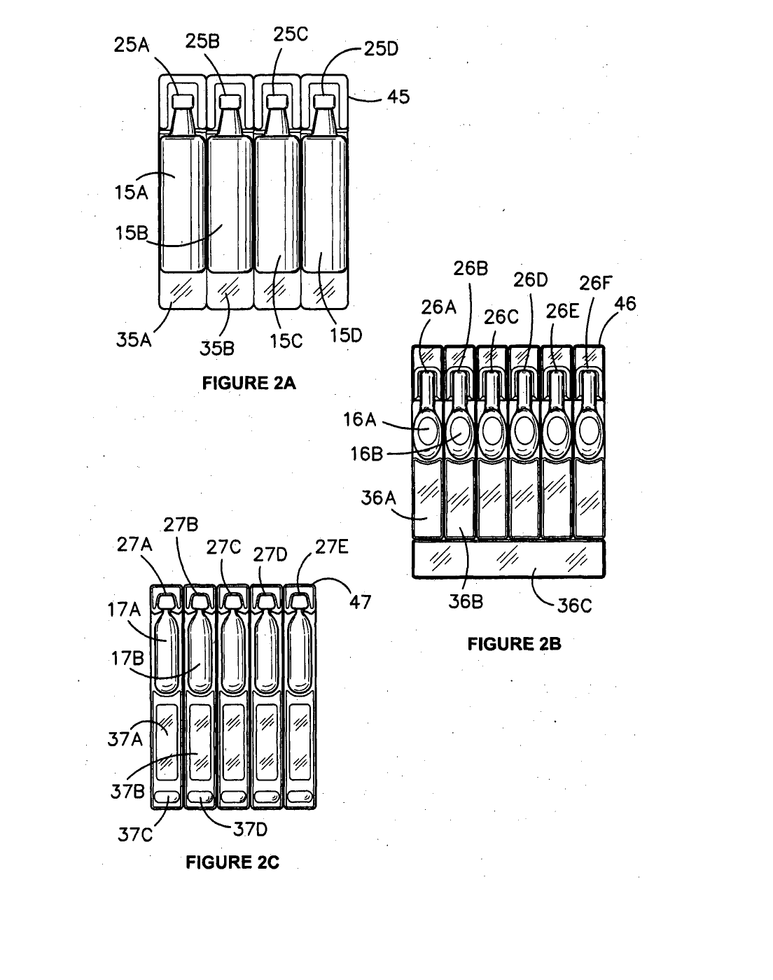

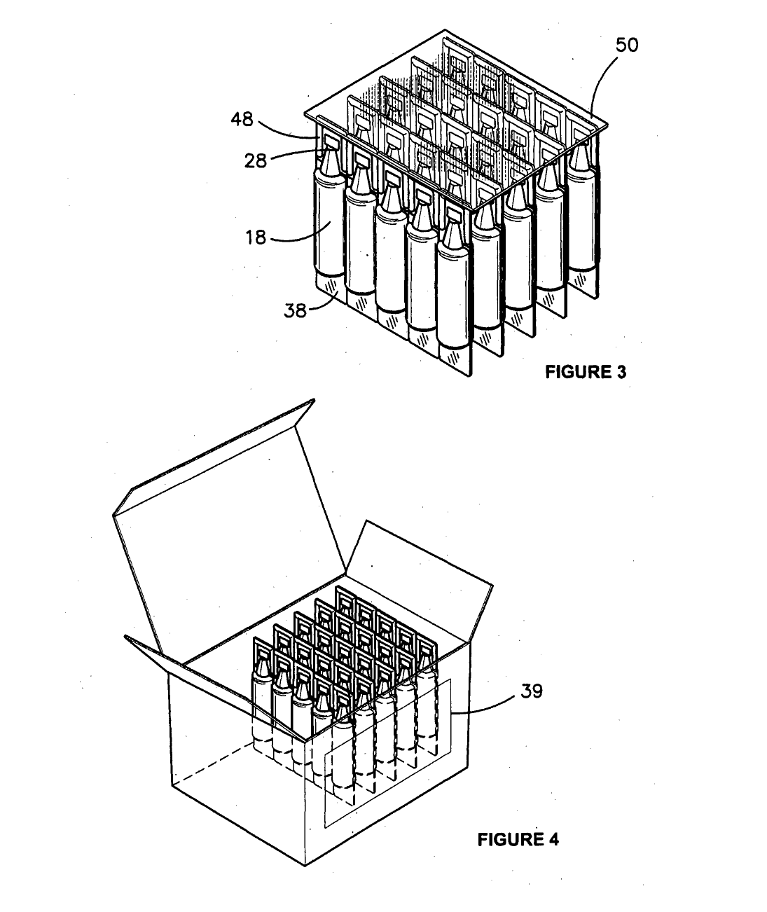

Examples of suitable strips of single-use containers for use in the present invention are shown in FIGS. 2 and 3.

FIG. 2 comprises FIGS. 2A, 2B and 2C, each of which show an elevational view of three different illustrative embodiments of strips of containers of the present invention, where the strips are rows of containers connected to each other.

In FIG. 2A, the reservoir of each container in the strip is indicated with 15A, 15B, 15C, and 15D; the outlet of one container comprising a cap or lid is indicated with 45; the opening of the outlet of each container (through which formulation is dispensed once the cap or lid has been removed) is indicated with 25A, 25B, 25C, 25D, and 25E; and 35A and 35B indicate suitable locations for labeling containers if labeled in accordance with some embodiments of the present invention.

In FIG. 2B, the reservoir of some of the containers in the strip is indicated with 16A and 16B; the outlet of one container comprising a cap or lid is indicated with 46; the opening of the outlet of each container (through which formulation is dispensed once the cap or lid has been removed) is indicated with 26A, 26B, 26C, 26D, 26E, and 26F; and 36A, 36B, and 36C indicate suitable locations for labeling containers if labeled in accordance with some embodiments of the present invention.

In FIG. 2C, the reservoir of some of the containers in the strip is indicated with 17A and 17B; the outlet of one container comprising a cap or lid is indicated with 47; the opening of the outlet of each container (through which formulation is dispensed once the cap or lid has been removed) is indicated with 27A, 27B, 27C, 27D, and 27E; and 37A, 37B, 37C, and 37D indicate suitable locations for labeling containers if labeled in accordance with some embodiments of the present invention.

FIG. 3 shows a perspective view of an illustrative embodiment of a strip of containers of the present invention, where the strip is a lattice of containers connected by 50. In FIG. 3, the reservoir of one of the containers in the strip is indicated with 18; the outlet of one container comprising a cap or lid is indicated with 48; the opening of the outlet of each container (through which formulation is dispensed once the cap or lid has been removed) is indicated with 28; and 38 indicates suitable locations for labeling containers if labeled in accordance with some embodiments of the present invention.

### 4. Packages

The present invention also provides packages comprising containers of the present invention and/or comprising strips of the present invention.

Suitable packages encompassed by the present invention include boxes, bags, jars, or similar packaging material containing loose or unconnected,single-use containers, or strips of containers.

An example of a suitable package for use in the present invention is shown in FIG. 4, which is a perspective view of an illustrative embodiment of a package of the present invention. In FIG. 4, 39 indicates one suitable location for labeling the package if the package is labeled in accordance with some embodiments of the present invention. It will be appreciated by one skilled in the art that this is not the only location on the package in FIG. 4 that where the package may be labeled.

### 5. Labels

The containers, strips and packages of the present invention may be labeled to indicate that certain containers are to be used at particular times.

The “time” indicated by the label as used herein may be a day of the week, for example Monday, Tuesday, Wednesday, etc, or a time of the day, for example morning, evening, or a specific chronological time of the day, for example 7:00 am, 10:30 am, 14:00 pm (or 2:00 pm), or similar. The time may also be a “time” that exists as part of a daily routine, for example a meal time such as breakfast, lunch, dinner, or otherwise, or another routine such as a habitual morning cup of coffee or tea, walking the dog, or evening tea or hot chocolate. The time may also be a combination of any of these times above, including but not limited to, “Monday breakfast” or “5:30 pm Sunday” or “Morning coffee”.

The labelling may be achieved by engraving, embossed text, graduations in the mold, or by attachment of a label to the surface of the container, or any other suitable labelling method known in the art.

The label may comprise text, images, or text and images, that indicate that certain containers are to be used at particular times.

The labelling may be anywhere on the container, strip of containers or packaging where it is visible to the consumer who is to dispense the formulation from the container for ingestion (typically the consumer, but may also be a carer if the formulation is to be taken by a child or other person who requires assistance). In specific embodiments, the label is at an end of each single-use container.

Where more than one container is present, such as in strips or packages, the labelling may be the same for each container indicating that each container is to be taken at the same time, for example, the formulation of one container is ingested each morning with a cup of coffee. In these embodiments, the formulation in each container may be the same formulation in each container or the formulation in some containers may be different to the formulation in other containers, or the formulation in each container may be different to the formulation in each other container.

In other embodiments, the labelling may be different for all or some containers, indicating that containers are to be taken at different times, for example the formulation of a first container in the strip or package is ingested with breakfast, and the formulation of a second container is ingested before bedtime. In these embodiments, the formulation in each container may be the same formulation in each container or the formulation in some containers may be different to the formulation in other containers, or the formulation in each container may be different to the formulation in each other container.

The containers, strips and packages of the present invention may be further labeled with standard information indicating the formulation held within the containers, including the medicinal and/or nutritional supplement(s) of the formulation, the dosage of each supplement, and/or the recommended daily dosage or otherwise, and/or the beneficial effect of the formulation, and/or other information, including but not limited to the batch numbers of the product or other manufacturer information.

### 6. Liquid Formulation

The formulations used in the present invention may comprise any suitable ingredient including one or more medicinal supplements, one or more nutritional supplements, or one or more medicinal supplements and one or more nutritional supplements. In specific embodiments the formulations consist essentially of one or more medicinal supplements, one or more nutritional supplements, or both one or more medicinal supplements and one or more nutritional supplements.

In some embodiments, the formulations comprise one or more medicinal supplements formulated to provide medicinal support for a particular individual, including those suffering from a disease or condition for which the medicinal supplement has been prescribed, including individuals with a chronic condition, a viral or bacterial infection or other illness, an addiction (e.g. nicotine), where the individual's condition can be assisted, alleviated or treated with the medicinal supplement. Medicinal supplements contemplated within the present invention include, but are not limited to, nicotine.

In some embodiments, the formulations comprise one or more nutritional supplements formulated to provide nutritional support for a particular individual, including to. support those individuals with a poor diet, excessive alcohol intake, inadequate exercise, weight problems, stress, lack of energy, or another health condition, including viral or bacterial infections or other illnesses, where the individual's condition can be assisted, alleviated or treated with nutrients. In some other embodiments, the formulation comprises one or more nutritional supplements formulated to provide support to an individual who desires additional nutritional support, including training athletes, or those who want to prevent or protect against infection or other illness.

Nutritional supplements contemplated within the present invention include, but are not limited to, lipids (e.g. fatty acids), suitable amino acids and derivatives thereof, peptides and proteins (including digestive enzymes e.g. proteases, peptidases, lipases, carbohydrases, nucleases), vitamins (e.g. vitamins A, B1, B2, B3, B5, B6, B7, B9, B12, C, E, H), choline, bio-available minerals (e.g. chloride, chromium, copper, magnesium, manganese, molybdenum, selenium, zinc), herbs and botanicals (e.g. barley grass, wheat grass, bioflavonoid, caffeine, cat's claw, chlorella, curcumin, echinacea, golden seal, gotu kola, guarana, hops, oats, oregano, passion flower, saw palmetto, spirulina), hormones (e.g. DHEA, melatonin, pregnenolone), antioxidants (e.g. glutathione, coenzyme Q10), inositol, lecithin, and precursors, derivatives, metabolites, constituents, concentrates, or extracts of any of the these. In specific embodiments, the formulation consists essentially of one or more vitamins and/or minerals and/or herbal extracts.

6.1 Lipids

Lipids are a diverse group of compounds that have many key biological functions, such as structural components of cell membranes and intermediates in signalling pathways. Some lipids are also needed to transport fat-soluble vitamins A, D, E and K, to insulate body organs against shock, to keep body temperature stable, and to maintain healthy skin and hair. Lipids also serve as energy stores for the body.

Lipids include fatty acids, some of which have been associated with lowering cholesterol, brain development, and growth. The body does not manufacture certain fatty acids (termed essential fatty acids) and the diet must supply these. Essential fatty acids include linolenic acid and linoleic acid. Fatty acids help with body functions such as blood pressure control, blood clotting and inflammation.

Evening primrose oil is a source of the omega-6 essential fatty acids gamma-linoleic acid and linoleic acid. Fish oil contains the omega-3 fatty acids eicosapentaenoic acid and docosahexaenoic acid. Linseed (or flaxseed) oil is also an important source of omega-3 fatty acids, as well as magnesium, zinc and dietary fibre.

6.2 Amino Acids and Derivatives Thereof

Amino acids are the building blocks for proteins, which are needed throughout the body. Amino acids are also important in many other biological molecules, such as forming parts of coenzymes, or as precursors for the biosynthesis of molecules. They are also an important source of nitrogen.

There are 22 amino acids, divided into essential and non-essential amino acids. Essential amino acids cannot be made by the body and therefore must come from the diet. There are nine essential amino acids: histidine, isoleucine, leucine, lysine, methionine, phenylalanine, threonine, tryptophan and valine.

Suitable amino acids for use in the present invention include the following amino acids.
6.2.1 Alanine

Alanine is an amino acid required for the metabolism of glucose and tryptophan. It is an important energy source for muscle tissue, the brain and central nervous system.
6.2.2 Arginine

Arginine is an amino acid that promotes wound healing and regeneration of the liver. It also promotes the release of hormones including glucagon, insulin, and growth hormone. Some believe that arginine assists with muscle growth.

Arginine also helps remove excess ammonia from the body, stimulates the immune function, may act as a natural blood thinner, and may help regulate cholesterol levels.

Arginine is also needed to increase protein synthesis, which can in turn increase cellular replication.

Research has suggested that arginine may assist increase sperm counts in men with low sperm counts, and may assist people with angina and/or congestive heart failure.
6.2.3 Aspartic acid

Aspartic acid is an amino acid important during construction of other amino acids and molecules in the Citric acid cycle, including asparagine, arginine, lysine, methionine, threonine, isoleucine, and nucleotides. It is also important in the functioning of RNA, DNA, as well as the production of immunoglobulins.

Aspartic acid also aids in the expulsion of harmful ammonia from the body.

Recent research also suggests that aspartic acid may increase resistance to fatigue and increase endurance.
6.2.4 Cysteine

Cysteine is an amino acid required for vitamin B6 utilisation, and assists in the supply of insulin to the pancreas, which is needed for the assimilation of sugars and starches. Cysteine is also necessarily for skin and hair formation, and is helpful in the healing of burns and wounds, breaking down mucus deposits in illnesses such as bronchitis and cystic fibrosis.

Cysteine functions as an antioxidant. It also increases the level of glutathione in the lungs, liver, kidneys and bone marrow, which may have an anti-aging effect on the body, for example by reducing age-spots.

Cysteine also strengthens the protective lining of the stomach and intestines.

Cysteine is rarely used itself as a dietary supplement, instead N-acetyl cysteine (NAC) is used.
6.2.5 Glycine

Glycine is one of the main amino acids of collagen, and is also helpful to bone, skin, and cartilage formation.
6.2.6 Histidine

Histidine is an amino acid needed for growth and repair of tissue, as well as for the manufacture of both red and white blood cells. It can also assist to remove heavy metals from the body.

Histidine has been used in the treatment of rheumatoid arthritis, allergic diseases, ulcers and anaemia. It is also believed to be beneficial for people with a shortage of gastric juices or suffering from indigestion.
6.2.7 Isoleucine

Isoleucine is an amino acid needed for the maintenance of muscle tissue, both to preserve muscle stores of glycogen and prevent muscle protein breakdown during exercise.
6.2.8 Leucine

Like isoleucine, leucine is an amino acid needed for maintenance of muscle tissue, both to preserve muscle stores of glycogen and prevent muscle protein breakdown during exercise.
6.2.9 Lysine

Lysine is an amino acid that is needed for growth and to maintain nitrogen balance in the body. It may also help the body absorb and conserve calcium. Lysine also helps form collagen which makes up bone cartilage and connective tissues and aids in the production of antibodies, hormones, and enzymes.

Some studies have shown that lysine may be effective against herpes and it is therefore often prescribed by doctors to people with cold sores or genital herpes.
6.2.10 Methionine

Methionine is an amino acid that is a principle supplier of sulphur which prevents disorders of the skin, hair, and nails. Methionine influences hair follicles and promotes hair growth.

Methionine also helps lower cholesterol levels by increasing the liver's production of lecithin. It also helps the liver process lipids and protects the kidneys.

It is also a natural chelating agent for heavy metals and regulates the formation of ammonia, helping to create ammonia-free urine which reduces bladder irritation.
6.2.11 Phenylalanine

Phenylalanine is an amino acid that exists in two stereoisomers: L-phenylalanine (LPA) and D-phenylalanine (DPA).

LPA can be converted to L-tyrosine (another amino acid) and subsequently to L-dopa,norepinephrine and epinephrine. Though a separate pathway, LPA can be converted to phenylethylamine which is a substance that occurs naturally in the brain and appears to elevate mood. It keeps you awake and alert, and reduces hunger pains.

It is believed that DPA may be helpful for some people with Parkinson's disease, and it has also been used to treat chronic pain.

A mixture of LPA and DPA has been used as an antidepressant.
6.2.12 Serine

This amino acid is required for the metabolism of fat, tissue growth and the immune system as it assists in the production of immunoglobulins and antibodies. It is also important in metabolism of nucleic acids, in the formation of cell membranes, and in creatine synthesis.
6.2.13 Taurine

Taurine is a derivative of the amino acid cysteine and is used in many energy products. Taurine, often referred to as an amino acid, is not part of the human body's structural proteins. Instead, taurine remains free in the tissues and bloodstream. In fact, taurine is one of the most abundant free amino-acid-like compounds found in the heart, the skeletal muscles and the nervous system. At times of extreme physical exertion, the body no longer produces the required amounts of taurine, which results in a relative deficiency. Taurine acts as a metabolic transmitter and is also known to have a detoxifying effect.

Nutritional supplements of the present invention formulated to provide amino acids to the individual may comprise polypeptides (including proteins), peptides, free amino acids (e.g. alanine), or amino acid derivatives (e.g. taurine).
6.2.14 Threonine

Threonine is is an amino acid that is an important constituent of collagen, elastin, and enamel protein. It helps to prevent fat build-up in the liver as well as assisting in the immune system by helping with the production of antibodies and promoting thymus growth and activity.

Threonine also assists in metabolism, assimilation and absorption of other nutrients.
6.2.15 Tryptophan

Tryptophan is an amino acid used as a sleep aid due to its ability to increase brain levels of serotonin and/or melatonin. Research has suggested that tryptophan can effectively treat the autumn/winter depression variant of seasonal affective disorder (SAD). It has also been used as an antidepressant.
6.2.16 Tyrosine

The amino acid tyrosine transmits nerve impulses to the brain and promotes the healthy functioning of the thyroid, adrenal and pituitary glands. Through its effect on neurotransmitters, it may affect several health conditions, including Parkinson's disease, depression, and other mood disorders.
6.2.17 Valine

Valine, like leucine and isoleucine, is an amino acid needed for the maintenance of muscle tissue, both to preserve muscle stores of glycogen and prevent muscle protein breakdown during exercise.

6.3 Proteins
6.3.1 Source of Amino Acids

Proteins are organic compounds that consists of the amino acids joined by peptide bonds. In nutrition, proteins are broken down into free amino acids. Proteins from different sources contain different amino acids. Proteins are therefore another source of amino acids for the body.
6.3.2 Digestive Enzymes

Enzymes catalyse the break down of polymeric macromolecules into their smaller building blocks. They therefore aid the digestion of food.

Enzymes are classified by their substrates: proteolytic enzymes (proteases and peptidases) catalyse the break down of proteins and other polypeptides into their amino acids, lipases catalyse the break down of fat into fatty acids, carbohydrases catalyse the breakdown of carbohydrates such as starch into sugars, and nucleases catalyse the breakdown of nucleic acids into nucleotides. Amylase is a specific carbohydrase that breaks starch into sugar.

Nutritional supplements containing proteolytic enzymes have been promoted for aiding digestion, reducing inflammation, cleansing the blood, strengthening the immune system, and killing moulds, fungi and viruses.

6.4 Vitamins

Vitamins are organic compounds required as a nutrient in tiny amounts by the body. A compound is called a vitamin when it cannot be synthesized in sufficient quantities by an organism, and must be obtained from the diet.
6.4.1 Vitamin A

Vitamin A influences the process of cell differentiation, and is therefore important in the growth and development of embryos. It is also important in vision (particularly night vision), normal bone and tooth development, and reproduction.

Deficiency symptoms of vitamin A also include night blindness, dry eyes (especially the cornea), and poor bone growth.

Vitamin A is also required for glycoprotein synthesis. In severe vitamin A deficiency, lack of glycoproteins may result, leading to corneal ulcers or liquefaction.

Vitamin A is also essential for the correct functioning of epithelial cells, especially skin and mucous membranes. In vitamin A deficiency, dry skin and acne are observed, and in severe deficiency, xerosis may occur.

Vitamin A also acts in the body as an antioxidant.

Vitamin A is fat-soluble. There are two sources of dietary vitamin A: active forms and precurors. Active forms are known as retinoids and include retinal and retinol.

They are immediately available to the body and are obtained from animal products. Precursors, also known as provitamins, must be converted to active forms by the body, are obtained from fruits and vegetables containing yellow, orange and dark green pigments, known as carotenoids, the most well-known being beta-carotene.
6.4.2 Vitamin B1 (Thiamin)

Vitamin B1 has essential metabolic roles in carbohydrate and protein metabolism (particularly in aiding in the release of energy from foods, and promoting normal appetite) and in neural function.

Common symptoms of thiamin deficiency often involve the nervous system and the heart, including neurodegeneration. In less severe deficiency, nonspecific signs include malaise, weight loss, muscle weakness, oedema, irritability and confusion.

A lack of thiamin can be caused by malnutrition, a diet high in thiaminase-rich foods (raw freshwater fish, raw shellfish, ferns) and/or foods high in anti-thiamin factors (tea, coffee, betel nuts), by grossly impaired nutritional status associated with chronic diseases, such as alcoholism, gastrointestinal diseases, HIV-AIDS, and persistent vomiting. It is thought that many people with diabetes have a deficiency of thiamin and that this may be linked to some of the complications that can occur.

Well-known syndromes caused by thiamin deficiency include beriberi and Wernicke-Korsakoff syndrome, diseases also common with chronic alcoholism.

There has been some suggestion that when a high dose of vitamin B1 (at least 100 mg for adults) is ingested, mosquitoes and other biting insects will either not land on the skin, or if they do they will not feed. In addition, vitamin B1 is known to have an anti-inflammatory effect. This means that high levels of vitamin B1 may assist in preventing insect bites from becoming too inflamed.

Vitamin B1 is a water-soluble vitamin.
6.4.3 Vitamin B2 (Riboflavin)

Vitamin B2 is required for a wide variety of cellular processes, including the manufacture of nucleic acid used in cell division, promotes good vision and healthy skin.

Deficiency of vitamin B2 may cause cracked and red lips, inflammation of the lining of the mouth and tongue, mouth ulcers, cracks at the corners of the mouth and a sore throat. A deficiency may also cause dry and scaling skin, fluid in the mucous membranes, and iron-deficiency anemia. The eyes may also become bloodshot, itchy, watery and sensitive to bright light. Riboflavin deficiency is classically associated with the oral-ocular-genital syndrome. Angular cheilitis, photophobia, and scrotal dermatitis are the classic remembered signs.

Vitamin B2 also assists the body in burning fat to avoid excessive fat storage. It is therefore useful in a weight loss diet because it helps convert the stored fat into energy and promote metabolic activity. Overweight or obese people often have a deficiency of vitamin B2. Therefore in order to promote fat metabolism, at least three times the amount of normal intake (1.5 mg/day) is recommended for obese people.

More recently there has been growing evidence that supplemental riboflavin may be a useful additive along with beta-blockers in the prevention of migraine headaches.

Vitamin. B2 is a water-soluble vitamin.
6.4.4 Vitamin B3 (Niacin)

Vitamin B3 a precursor to components that play essential metabolic roles in living cells. It is also involved in both DNA repair, and the production of steroid hormones in the adrenal gland. It promotes healthy skin and nerves.

Vitamin B3 has been implicated in increasing the rate of wound healing and. helping the immune system to fight off infection. Vitamin B3 also affects fat metabolism, and has therefore been previously prescribed for patients with low high-density lipoprotein (HDL). It is also believed to aid digestion and promote healthy appetite.

Severe deficiency of vitamin B3 in the diet causes the disease pellagra, whereas mild deficiency slows the metabolism, causing decreased tolerance to cold temperatures. Deficiency syndromes also include skin disorders, diarrhea, weakness, mental confusion and irritability.

Vitamin B3 is water-soluble and can be supplied as niacin (nicotinic acid) or niacinamide.
6.4.5 Vitamin B5 (Pantothenic Acid)

Vitamin B5 is used in the synthesis of coenzyme A, and is considered critical in the metabolism and synthesis of carbohydrates, proteins, and fats.

Symptoms of deficiency are similar to other vitamin B deficiencies. Most are minor, including difficulty sleeping, fatigue, allergies, nausea, and abdominal pain. In a few rare circumstances more serious (but reversible) conditions have been seen, such as adrenal insufficiency and hepatic encephalopathy.

Vitamin B5 is water-soluble and can be supplied as pantothenic acid, calcium pantothenate, or its provitamin panthenol.
6.4.6 Vitamin B6 (Pyroxidine, Pyridoxal, or Pyridoxamine)

Vitamin B6 assists in the balancing of sodium and potassium as well as promoting red blood cell production. It is linked to cardiovascular health by decreasing the formation of homocysteine. It also helps the body in protein and fat metabolism.

A vitamin B6 deficiency may cause anemia, kidney stones, nausea, nerve damage, seizures, skin problems, and skin disorders including dermatitis, cracks at corners of mouths, skin sores in the mouth, and smooth tongue.

It has been suggested that vitamin B6 might help children with learning difficulties, and may also prevent dandruff, eczema, and psoriasis.

In addition, vitamin B6 can help balance hormonal changes in women and aid in immune system. It has also been implicated in the treatment of depression and anxiety.

Vitamin B6 is a water-soluble vitamin.
6.4.7 Vitamin B7 (Biotin, Vitamin H)

Vitamin B7 is necessary for cell growth, the production of fatty acids, and the metabolism of fats and amino acids. It plays a role in the Citric acid cycle, which is the process by which biochemical energy is generated during aerobic respiration. Vitamin B7 not only assists in various metabolic reactions, but also helps to transfer carbon dioxide.

Vitamin B7 is also helpful in maintaining a steady blood sugar level. In addition, it is often recommended for strengthening hair and nails.

Vitamin B7 deficiency include fatigue, loss of appetite, nausea, vomiting, depression, muscle pains, anemia, and retarded growth. Dermatologic symptoms include dermatitis, alopecia and achromotrichia (absence or loss of pigment in the hair). Perosis (a shortening and thickening of bones) is seen in the skeleton. Fatty Liver and Kidney Syndrome (FLKS) and hepatic steatosis also can occur. In addition, people with type 2 diabetes often have low levels of biotin.

Vitamin B7 is a water-soluble vitamin.
6.4.8 Vitamin B9 (Folate, Folic Acid, Folacin)

Vitamin B9 is necessary for the production and maintenance of new cells, which is especially important during periods of rapid cell division and growth such as infancy and pregnancy. Vitamin B9 also aids in protein metabolism.

Vitamin B9 deficiency can lead to loss of appetite and weight loss.

Additional signs are diarrhea, weakness, sore tongue, headaches, heart palpitations, irritability, and behavioral disorders. Women with vitamin B9 deficiency who become pregnant are more likely to give birth to low birth weight and premature infants, and infants with neural tube defects. In infants and children, vitamin B9 deficiency can slow growth rate. Anemia in adults is a sign of advanced vitamin B9 deficiency.

Some situations that increase the need for folate include pregnancy and lactation (breastfeeding), tobacco smoking, malabsorption, including celiac disease, kidney dialysis, liver disease, certain anemias, and certain medications.

Vitamin B9 is a water-soluble vitamin.
6.4.9 Vitamin B12 (Cyanocobalamin)

Vitamin B12 has a key role in the normal functioning of the brain and nervous system, and for the formation of blood. It is normally involved in the metabolism of every cell of the body, especially affecting DNA synthesis and regulation, but also fatty acid synthesis and energy production.

Vitamin B12 deficiency is the cause of pernicious anemia, the treatment of which is often vitamin B12. Deficiency of either vitamin B12 is also associated with fatigue, depression and poor memory.

Vitamin B12 is a water-soluble vitamin.
6.4.10 Vitamin C (Ascorbic Acid)

Vitamin C is essential for the formation, growth, and repair of bone, skin, and connective tissue (which binds other tissues and organs together and includes tendons, ligaments, and blood vessels). Vitamin C helps maintain healthy teeth and gums. It helps the body to absorb iron, which is needed to make red blood cells, and to absorb calcium and folacin. Vitamin C also helps burns and wounds heal. Vitamin C is also an antioxidant and therefore protects cells against damage by free radicals, which are by-products of normal cell activity that participate in chemical reactions. Some of these reactions can be harmful.

Vitamin C is also involved in the production of brain hormones and immune factors.

Vitamin C deficiency can make individuals tired, weak and irritable. Severe deficiency of vitamin C can lead to bleeding gums, wounds that do not heal, an individual who bruises easily, dry skin, rough skin, and may lead to scurvy. Other deficiency syndromes include sore joints and bones and increased susceptibility to infection.

Vitamin C is water-soluble and can be supplied as a nutrient as ascorbic acid, sodium ascorbate, calcium ascorbate, or fatty acid esters of ascorbic acid: (i) ascorbyl palmitate (ii) ascorbyl stearate.
6.4.11 Vitamin E

Vitamin E acts as an antioxidant, protecting cells against damage by free radicals.

Symptoms of vitamin E deficiency may include slow reflexes, difficulty walking, loss of coordination, loss of position sense (knowing where the limbs are without looking at them), and muscle weakness. Vitamin E deficiency can cause a form of anemia in which red blood cells rupture (hemolytic anemia).

In addition, many people take vitamin E to help prevent certain disorders.

6.5 Choline

Choline is an organic compound, classified as a.water-soluble essential nutrient and usually taken with various vitamin B nutrients, such as a vitamin B complex. This natural amine is found in the lipids that make up cell membranes and in the neurotransmitter acetylcholine.

Choline is used to prevent heart disease. Choline is often taken as a form of ‘smart drug’ or nootropic, due to the role that the neurotransmitter acetylcholine plays in various cognition systems within the brain. It is also an essential nutrient needed by the peripheral nervous system.

Due to its role in lipid metabolism, choline is also sometimes included in nutritional supplements to assist in fat and cholesterol metabolism. Choline also aids in hormone production, and helps boost the libido and erectile function. Choline is also taken to assist people with urinary retention.

Choline is also believed to be beneficial to pregnant women for the proper cognitive development of their fetuses and newborn babies, and for those who suffer from sleep disturbances.

Deficiencies of choline include a fatty liver (where fatty deposits develop in the liver), cardiac problems, high blood pressure, and an inability to digest fats.

Lecithin (discussed separately herein) is one source of choline.

6.6 Bio-available Minerals

Dietary minerals or bio-available minerals are the chemical elements required by living organisms to function, other than the four elements: carbon, hydrogen, nitrogen, and oxygen present in common organic molecules. The term “mineral” is archaic, since the intent of the definition is to describe ions, not chemical compounds or actual minerals.
6.6.1 Chloride

Chloride travels primarily with sodium and water and helps generate the osmotic pressure of body fluids. It is an important constituent of stomach hydrochloric acid (HCl), the key digestive acid. Chloride is also needed to maintain the body's acid-base balance. Chloride may also be helpful in allowing the liver to clear waste products.

A deficiency of chloride can be caused by fluid loss as a result of excessive sweating, vomiting, or diarrhoea. Use of medications such as diuretics can also cause a deficiency.

Chloride deficiency may result in alkalosis, dehydration, loss of potassium, muscle weakness and lowered blood pressure.

Different forms of chloride include, but are not limited to, sodium chloride and calcium chloride.
6.6.2 Chromium

Chromium (trivalent chromium-Cr(III) or Cr3+) is known to enhance the action of insulin, a hormone critical to the metabolism and storage of carbohydrate, fat, and protein in the body. Chromium also appears to be directly involved in carbohydrate, fat, and protein metabolism.

Chromium deficiency may cause a disease called chromium deficiency which may include displaying diabetes-like symptoms. The body's chromium content may be reduced under several conditions. For example, individuals with diets high in simple sugars (comprising more than 35% of calories) can exhibit increased chromium excretion in the urine. In addition, infection, acute exercise, pregnancy and lactation, and stressful states (such as physical trauma) increase chromium losses and can lead to deficiency, especially if chromium intakes are already low.

Chromium is a widely used supplement, available as chromium chloride, chromium nicotinate, chromium picolinate, high-chromium yeast, and chromium citrate. Both vitamin B3 and vitamin C enhancing the absorption of chromium in the body.
6.6.3 Copper

Copper is found in a variety of enzymes, and is also used for biological electron transport. Copper plays a role in facilitating iron uptake.

It is believed that zinc and copper compete for absorption in the digestive tract so that a diet that is excessive in one of these minerals may result in a deficiency in the other.

Copper deficiency can often produce anemia-like symptoms. Chronic copper depletion leads to abnormalities in metabolism of fats, high triglycerides, non-alcoholic steatohepatitis (NASH), fatty liver disease and poor melanin and dopamine synthesis causing depression and sunburn.
6.6.4 Fluoride

Fluoride assists with mineralisation of enamel, which reduces dental decay.
6.6.5 Iodine

Iodine is converted to iodide in the gut and is then trapped by the thyroid gland, where it forms an integral part of thyroid hormones. Thyroid hormones regulate cell activity and growth in virtually all tissues, and a well functioning thyroid is essential for speech, hair, skin and teeth.
6.6.6 Iron

Iron combines with protein and copper to make haemoglobin, which transports oxygen in the blood. Iron is responsible for building up the quality of the blood and increases resistance to stress and disease. Iron is also important for formation of myoglobin in muscle tissue.

Iron is also, needed to prevent fatigue and to promote good skin tone.
6.6.7 Magnesium

Due to the important interaction between phosphate and magnesium ions, magnesium ions are essential to the basic nucleic acid chemistry of life. Many enzymes require the presence of magnesium ions for their catalytic action, including all enzymes utilizing or synthesizing ATP, or those which use other nucleotides to synthesize DNA and RNA. ATP exists in cells normally as a chelate of ATP and a magnesium ion. Magnesium also appears to facilitate calcium absorption.

Magnesium deficiency has been implicated in the development of a number of human illnesses such as asthma, osteoporosis, and ADHD. Alcoholism can produce a magnesium deficiency which is easily reversed by magnesium administration, depending on the degree of deficiency.
6.6.8 Manganese

Manganese is an essential mineral. It is present in cofactors for a large number of enzymes.

A deficiency in manganese causes skeletal deformation and inhibits the production of collagen in wound healing. Many nutritionists attribute joint pain, inflammation, arthritis, bursitis, dermatitis, and many diseases including Parkinson's disease, osteoporosis, schizophrenia, diabetes, and epilepsy to manganese deficiency.
6.6.9 Molybdenum

The most important use of the molybdenum atom in living organisms is as a metal hetero-atom at the active site in certain enzymes. Molybdenum concentrations in the body affect protein synthesis, metabolism, and growth.

Molybdenum is also present within human tooth enamel and may help prevent the decaying thereof.

Although molybdenum deficiency is rare; if the body does not get enough molybdenum, certain enzymes needed by the body are affected. This may lead to a build up of unwanted substances in some people.
6.6.10 Phosphorus

Phosphorus is involved in bone and teeth formation, as well as metabolism, kidney function, cell growth and heat muscle contraction. It helps in the conversion of food to energy, and also in vitamin utilisation.
6.6.11 Selenium

Selenium is toxic in large amounts, but trace amounts of it are necessary for cellular function. Selenium forms the active centre of some enzymes, and is also necessary for the conversion of normal thyroid function.

Selenium deficiency can occur in patients with severely compromised intestinal function, those undergoing total parenteral nutrition, and also advanced aged people (over 90). Alternatively, people dependent on food grown from selenium-deficient soil are at risk of selenium deficiency.

Selenium deficiency can cause symptoms of hypothyroidism, including extreme fatigue, mental slowing, goitre, cretinism and recurrent miscarriage. It can also lead to Keshan disease, which is potentially fatal. Selenium deficiency also contributes (along with iodine deficiency) to Kashin-Beck disease.
6.6.12 Zinc

Zinc is necessary for sustaining all animal life, involved in many biological pathways.

Zinc is believed to possess antioxidant properties. Zinc is also believed by some to speed up the healing process after an injury. Zinc can also be part of an effective treatment for age-related macular degeneration.

Zinc deficiency is usually nutritional, but can also be associated with malabsorption, acrodermatitis enteropathica, chronic liver disease, chronic renal disease, sickle cell disease, diabetes, malignancy, and other chronic illnesses.

6.7 Herbs and Other Botanicals

Many herbs and other plant-derived components including botanicals are now commonly taken as nutrients. Illustrative examples of those suitable as nutrients, for the nutrient supplement of the present invention are described below.
6.7.1 Andrographis

Andrographis is an Ayurvedic herb which has been used for hundreds of years in Chinese and Indian medicine to reduce the symptoms associated with the common cold, such as fever, sore throats and coughs, and aid in the recovery from the common cold.

Andrographolide, the major active constituent of Andrographis, helps to reduce fever and inflammation, as well as stimulating the immune system.
6.7.2 Anemarrhena

Anemarrhena is a Chinese herb with sedative and nutritive properties, traditionally used for nurturing yin and relaxing tension. Anemarrhena has sedative properties, making it useful for assisting with sleep and relaxation.
6.7.3 Artichoke (Cynara scolymus)

Artichoke has traditionally been used to stimulate bile production, and to move bile to the gallbladder and then into the intestines. The ability of artichoke to increase bile flow helps improve fat metabolism in^{-the body.}

Artichoke is also believed to support the liver, both by protecting the liver from toxins, as well as increasing the regeneration of liver cells.

6.14 Astragalus Membranaceus Root

This root is traditionally used in Chinese medicine as a tonic and to prevent immune-depressing conditions. Astragalus has immune enhancing, antibiotic and anti-viral properties and is now widely used in herbal medicine in the prevention and treatment of colds and flu, as well as to maintain immune system health.
6.7.5 Aztec Marigold

This plant has a history of use for many digestive conditions such as stomach ache, indigestion and vomiting.

Aztec marigold has a high concentration of lutein, which is an antioxidant carotenoid, and helps protect the eyes from free radical damage and assists with the maintenance of vision.
6.7.6 Barberry

Barberry is a bitter tasting spleen tonic, and also has antibacterial and anti-inflammatory properties. It should be avoided during pregnancy.
6.7.7 Barley Grass (Hordeum vulgare) and Wheat Grass (Triticum asetivum)

The young shoots of the barley grass is rich with chlorophyll, enzymes required by the body, vitamins, minerals and amino acids. Chlorophyll is the green pigment found in the barley shoots and helps increase oxygen availability in the body. Chlorophyll is also vital for the body's rapid assimilation of amino acids.

The alkaline nature of green barley is also very beneficial for the body.

Barley green is particularly valuable when an individual's diet lacks sufficient fresh, raw vegetables. Powdered dehydrated leaves of young plants of these two species are often taken as nutrients.
6.7.8 Bearberry (Uva ursi)

Bearberry is very beneficial for the urinary system, where it has both astringent and antiseptic properties.
6.7.9 Bilberry (Vaccinium myrtillus)

Bilberry is used for the treatment of poor night vision, day blindness, cataracts, macular regeneration and glaucoma. It contains anthocyanosides, which strengthen the blood vessel walls, reduce inflammation, and generally stabilise all tissues containing collagen.

Bilberry is also used as an antiseptic and an anti-inflammatory agent, including to treat inflammation of the mucus membranes of the mouth and throat.
6.7.10 Bioflavonoid

Bioflavonoids (sometimes called flavonoids) are plant secondary metabolites usually derived from citrus fruit rinds, but may also come from cherries, blackcurrants, buckwheat, garlic, grapes, green tea, onions, peppers, pine bark and other sources. Examples of bioflavonoids are citrin, hesperidin, rutin, quercetin, flavines, and flavonals.

Bioflavonoids have reported antioxidant and anti-inflammatory properties, and help maintain the capillary walls, reducing the likelihood of bleeding or bruising. It is believed that not only do bioflavonoids act as antioxidants themselves by removing free radicals from the body's system, but they also increase the action of other antioxidants (including vitamin C).

It has been suggested that bioflavonoids have an antibacterial effect, stimulate bile production, promote circulation and even assist in fighting allergies, including allergic rhinitis (hay fever) and asthma. Bioflavonoids also help with to lower blood cholesterol levels and play a part in the prevention and treatment of cataracts.
6.7.11 Black cohosh (Actaea racemosa)

This herb (formerly named Cimicifuga racemosa) is native to North America. The roots and rhizomes of this herb are used in the treatment of menopausal symptoms and menstrual dysfunction.
6.7.12 Brahmi (Bacopa monniera)

Brahmi is bitter in taste, and has been used in the Ayurvedic system of medicine for centuries for the treatment of a number of disorders, particularly those involving anxiety, intellect and poor memory. It has also been used to enhance memory development, learning, and concentration. It is also believed to have antioxidant properties.
6.7.13 Buchu

Buchu has diuretic properties, making it useful for urinary tract infections and conditions of excess fluid. It has also been found to have antiseptic properties which complement it's use for urinary tract infections.
6.7.14 Caffeine

Caffeine is an alkaloid found in varying quantities in the beans, leaves, and fruit of some plants, including guarana.

Caffeine is a mild diuretic, and a central nervous system (CNS) stimulant, having the effect of temporarily warding off drowsiness and restoring alertness.
6.7.15 Calendula

Calendula has anti-inflammatory, astringent, antiseptic, antiviral, and antibacterial properties and helps boost the immune system.

Calendula has been used for scrapes, eczema, burns, haemorrhoids, varicose veins, and wounds that are healing poorly. It has also been used to treat fungal infections such as thrush.
6.7.16 Cat's Claw (Uncaria tomentosa)

Cat's claw is a is a woody vine found in the tropical jungles of South and Central America, which derives its name from its claw-shaped thorns. It contains several alkaloids, tannins and phytochemicals.

As a herbal treatment, Cat's claw is used to treat intestinal ailments such as Crohn's disease, gastric ulcers and tumors, parasites, colitis, gastritis, diverticulitis and leaky bowel syndrome. Other asserted health benefits include the treatment of AIDS in combination with AZT, the treatment and prevention of arthritis and rheumatism, diabetes, PMS, chronic fatigue syndrome, prostate conditions, immune modulation, Lyme disease and systemic lupus erythematosus. There has been supporting evidence toward its use in treating cancer, inflammation, viral infection and vascular conditions, and for its use as an immunostimulant, antioxidant, antibacterial and CNS-related agent.
6.7.17 Celery Seed

Celery seed is used primarily as a diuretic, increasing urine output to help the body get rid of excess water. Celery seed is also used for treating arthritis and gout, and to help reduce muscle spasms, calm the nerves, and reduce inflammation.
6.7.18 Chlorella

Chlorella is a genus of single-celled green algae, belonging to the phylum Chlorophyta.

Chlorella contains main nutrients including protein, fat, vitamins, and minerals. Under certain growing conditions, chlorella yields oils high in polyunsaturated fats. Chlorella also contains more chlorophyll than most plants, and more nucleic acids than any other food which gives it a lot of energy-producing potential. It is a great supplement to boost any diet lacking in green vegetables.

The support of weight control, cancer prevention, natural detoxification, digestive health, immune function, inflammation reduction, antioxidant function, oestrogen balance, cholesterol metabolism, and circulation, are all positive health benefits attributed to this algae.
6.7.19 Coleus forskohlii

Coleus forskohlii is a botanical where the root portion containing the active constituent (forskolin) has been used since ancient times in Hindu and Ayurvedic traditional medicine. This botanical has been used to treat hypertension, congestive heart failure, eczema, colic, respiratory disorders, painful urination, insomnia, and convulsions. Clinical studies of the plant and forskolin support these traditional uses, and have also indicated that the plant and forskolin may have therapeutic benefit in asthma, angina, psoriasis, and prevention of cancer metastases.
6.7.20 Curcumin

Curcumin is the principal curcuminoid of the popular Indian curry spice turmeric. Turmeric has been used historically as a component of Indian Ayurvedic medicine to treat a wide variety of ailments. Research in the latter half of the 20th century has identified curcumin as responsible for most of the biological activity of turmeric.

It is believed that curcumin may have antitumor, antioxidant, antiarthritic, anti-amyloid, anti-ischemic, anti-inflammatory and anti-viral properties. In addition it may be effective in treating malaria. It is also hepatoprotective.

There is also circumstantial evidence that curcumin improves mental functions and may inhibit the accumulation of destructive beta-amyloid in the brains of Alzheimer's disease patients and also break up existing plaques associated with the disease.

Numerous studies have demonstrated that curcumin, amongst only a few other things such as high impact exercise, learning, bright light, and antidepressant usage, has a positive effect on neurogenesis in the hippocampus and concentrations of brain-derived neurotrophic factor (BDNF), reductions in both of which are associated with stress, depression, and anxiety.
6.7.21 Damiana (Turnera diffusa)

Damiana has been a part of traditional Central American folk medicine and is still used today as a herbal remedy.
6.7.22 Dandelion Root (Taraxacum officinale)

Dandelion root is an antiviral agent used as an appetite stimulant, a digestive aid, and may improve the health and function of natural bacteria in the gastrointestinal tract.
6.7.23 Devil's Claw (Harpagophytum procumbens)

Devil's claw has been used to treat all types of joint pain, including osteoarthritis, rheumatoid arthritis, and gout, and soft tissue pain such as back pain. It is believed to reduce inflammation and pain, and acts as a diuretic, sedative, and digestive stimulant.

Devil's claw has also been used to treat liver, gallbladder, and kidney problems, and reduce menopausal symptoms.
6.7.24 Echinacea

Echinacea is a plant, with extracts believed to have antimicrobial, alterative, antiseptic, antibacterial, and immune stimulant properties. Echinacea is taken to help rid the body of microbial infections. It is found in most herbal cold, flu and fever formulas. For this purpose it combines well with golden seal.
6.7.25 Fenugreek (Trigonella foenum-graecum)

Fenugreek acts as a demulcent which helps to soothe inflamed mucous membranes.
6.7.26 Garlic (Allium sativum)

Garlic has traditionally been used for the relief of hayfever, coughs, colds, flu and rhinitis. Garlic contains sulphur-containing compounds which are believed to eb responsible for many of the beneficial actions of garlic.
6.7.27 Gentian (Gentiana lutea)

Gentian is used to aid digestion. It stimulates the appetite, improves circulation, and can help prevent heartburn. Gentian can help normalise the functioning of the thyroid and may be useful in the treatment of ulcers. It also kills plasmodia, the cause of malaria, and worms. Gentian is also believed to be beneficial for those suffering from pancreatitis.
6.7.28 Gingko (Gingko biloba)

Gingko increases blood flow and helps normalise circulation as it has a relaxing effect on arteries and a toning effect on veins. Gingko increases the fluidity of blood and by improving circulation can enhance utilisation of oxygen and glucose by the body.
6.7.29 Golden Seal (Hydrastis canadensis)

Golden seal is a perennial herb in the buttercup family.

Goldenseal is often used as a multi-purpose remedy, having many different medicinal properties. In addition to working as a topical antimicrobial, it can also be taken internally as a digestion aid, and can remove canker sores when gargled with.
6.7.30 Gotu Kola (Centella asiatica)

Gotu kola is a small herbaceous annual plant. It is a mild adaptogen, is mildly antibacterial, anti-viral, anti-inflammatory, anti-ulcerogenic, anxiolytic, a cerebral tonic, a circulatory stimulant, a diuretic, nervine and vulnerary.

Gotu kola is typically used to assist in the relief of fatigue, mild anxiety and stress, and helps to increase mental function.
6.7.31 Grape Seed (Vitis vinifera)

Grape seed extract contains a rich source of plant flavonoids called oligomeric procyanidins, known to have beneficial effects on the body including stabilising capillary walls and preventing increases in capillary permeability. The extract supports collagen structures and helps prevent destruction of collagen.
6.7.32 Guarana (Pauiinia cupana)

Guarana is a climbing plant in the Sapindaceae family.

Guarana contains caffeine and other components, and is often used for an energy boost. There has been some evidence that guarana assists cognitive improvement including memory retention, alertness, mood and physical endurance. Guarana is believed by some to have other medicinal effects.
6.7.33 Hops Flower

Hops are the female flower cones, also known as strobiles, of the hop plant (Humulus lupulus).

Hops are also used in herbal medicine in a way similar to valerian, as a treatment for anxiety, restlessness, and insomnia. Hops has been considered especially useful in alleviating nervous stomach conditions and in helping produce sleep. Hops is also a diuretic and vermifuge.

Hops is also an excellent herbal source of vitamin B3.
6.7.34 Horseradish (Armoracia rusticana)

Horseradish contain mustard oils which are believed to be the constituents that give it the traditionally recognised decongestant effects.
6.7.35 Horsetail (Equisetum arvense)

Horsetail has traditionally been used as a diuretic for the treatment of edema, and has also been used for osteoporosis, nephrolithiasis (kidney stones), and urinary tract inflammation.
6.7.36 Hydroxycitric Acid (HCA)

HCA is an acidic chemical compound produced in the fruit of Garcinia cambogia and has been used for gastrointestinal complains and rheumatism.

Garcinia cambogia has been used to help individuals lose weight.
6.7.37 Indian Ginseng (Withania somnifera, Also Known as Ashwaganda)

Indian ginseng is an adaptogenic herb, useful to promote homeostasis in conditions relating to stress. Clinical trials support the use of ashwaganda for anxiety, cognitive and neurological disorders, inflammation and Parkinson's disease.

Ashwaganda is commonly found in women's preparations as it also assists with balancing hormones.

It has also been used as an aphrodisiac, liver tonic, astringent, to treat bronchitis, asthma, ulcers, emaciation, insomnia and senile dementia.
6.7.38 Korean Ginseng (Panax ginseng)

Korean ginseng is used in Chinese medicine to replenish vital energy and promote health. It is believed to revitalise the body as a whole and increase the overall wellbeing of a person by supporting energy levels and reducing fatigue.
6.7.39 Lycopene

Lycopene, found primarily in tomatoes, is a member of the carotenoid family (which includes beta-carotene) and has potent antioxidant capabilities.
6.7.40 Milk Thistle (Silybum marianum)

Milk thistle has been used as a remedy for depression and liver problems. Recent research has confirmed that it has remarkable activity to protect the liver from damage resulting from alcoholic and other types of poisoning.

It has been used for the treatment of liver and gall bladder diseases, jaundice, cirrhosis, hepatitis and poisoning.
6.7.41 Oats (Avena sativa)

This is a species of cereal grain grown for its seed.

Oats contain more soluble fiber than any other grain, including beta-glucans, and has been proven to help lower LDL (“bad”) cholesterol. It is also believed that it may reduce the risk of heart disease.

Oat straw has also been used to treat numerous ailments including arthritis, rheumatism and fluid retention. Some herbalists recommend oat straw for treating shingles, herpes infections, and addictions.
6.7.42 Olive Leaf Extract

Olive leaf extract is an anti-viral, anti-bacterial, anti-fungal, and anti-inflammatory agent which has been shown to be effective in the treatment of many conditions where antibiotics and conventional medications have been found to be ineffective.
6.7.43 Oregano (Oreganum vulgare)

Oregano is a perennial herb.

It has both antioxidant activity and antimicrobial activity. Oregano has also been used to soothe sore throats and relieve coughs. The leaves and flowering stems are strongly antiseptic, antispasmodic, carminative, cholagogue, diaphoretic, emmenagogue, expectorant, stimulant, stomachic and mildly tonic. Aqueous extracts, capsules, or oil extracts are mouth for the treatment of colds, influenza, mild fevers, fungal infections, indigestion, stomach upsets, enteric parasites, and painful menstruation.

It is strongly sedative and should not be taken in large doses, though mild teas have a soothing effect and aid restful sleep.
6.7.44 Passion Flower (Passiflora incarnate)

This plant has been used to treat anxiety, stress, insomnia, hysteria, and epilepsy, and is also valued for its painkilling properties. It contains many active ingredients including betacarboline harmala alkaloids which are MAOIs with anti-depressant properties. Other medicinal properties are believed to exist.
6.7.45 Saw Palmetto (Serenoa repens)

The fruits of the saw palmetto are highly enriched with fatty acids and phytosterols, and extracts of the fruits have been the subject of intensive research for the treatment of urinary tract infections.

Saw palmetto is also commonly used for other medicinal purposes, including as a diuretic, as an expectorant and to relieve phlegm-producing conditions such as colds and flus, to relieve painful periods and regulate the menstrual cycle, for pelvic inflammatory disease and similar conditions, and for benign prostatic hyperplasia or when the prostate is beginning to enlarge.
6.7.46 Siberian Ginseng

Siberian ginseng has been shown to improve mental and physical performance, to minimise the effects of stress, and to support immune function.
6.7.47 Spirulina

Spirulina comes from two different species of cyanobacteria: Arthrospira platensis, and Arthrospira maxima. Both are found in the alkaline waters of shallow lakes.

Spirulina is a rich source of many nutrients. It is higher in protein, vitamin B12 and iron than most other food sources. It also contains liberal quantities of beta-carotene, chlorophyll, vitamin E, calcium, magnesium, phosphorus, potassium, and zinc.

Because spirulina is particularly nutritious it is often taken as a slimming supplement. If taken 30 minutes before eating, it is believed the natural, concentrated amino acid content of this algae can trick the brain into believing that the appetite has been satisfied after only a little food has been consumed.
6.7.48 St John's Wort (Hypericum perforatum)

St John's Wort is mainly used for the treatment of mild to moderate depression, but can also be used for chromic insomnia and anxiety related to depression. It may also be effective in relieving the symptoms of seasonal affective disorder.
6.7.49 Valerian (Valeriana officinalis)

Valerian is known to effect the nervous system, and produce drowsiness and sleep.
6.7.50 Zeaxanthin

Zeaxanthin is a carotenoid found concentrated in the central part of the retina. It is a powerful. antioxidant.

6.8 Hormones

Hormones are chemical messengers that transport a signal from one cell to another. Many hormones and their analogues are used as medication. Some are available as nutrients and do not require prescription from a medical practitioner.
6.8.1 DHEA (Dehydroepiandrosterone)

DHEA is a multi-functional steroid hormone that has been implicated in a broad range of biological effects in humans and other mammals.
6.8.2 Melatonin

The primary motivation for the use of melatonin as a supplement may be as a natural aid to better sleep, and therefore can have beneficial effects for treatment of certain forms of insomnia and jet-lag. Incidental benefits to health and well-being may accumulate, due to melatonin's role as an antioxidant and its stimulation of the immune system and several components of the endocrine system.
6.8.3 Pregnenolone

Pregnenolone is a steroid hormone sometimes taken for various purposes.

6.9 Antioxidants

Antioxidants are molecules capable of slowing or preventing the oxidation of other molecules. In the body, oxidation reactions can produce free radicals, which start chain reactions that damage cells. Antioxidants terrninate these chain reactions. They are used to treat forms of brain injury (as the brain is uniquely vulnerable to oxidative injury), help prevent some diseases, and appear to protect against cancer.

Some of the nutrients already described herein have antioxidant properties, including, vitamin A, vitamin C, vitamin E, zinc, bioflavonoids, cat's claw, curcumin, oregano and meltonin.
6.9.1 Glutathione

Glutathione is a tripeptide made up of gamma-glutamic acid, cysteine, and glycine, and is also known as gamma-glutamylcysteinelglycine or GSH. Glutathione is found in every cell of the body, and is therefore an important antioxidant. It also regulates the actions of lesser antioxidants such as vitamin C and vitamin E. If the levels of glutathione are too low in the body, other antioxidants are unable to do their job.

Glutathione is the regulator and regenerator of immune cells and it is the most valuable detoxifying agent in the body. It is important in DNA synthesis and repair, protein and prostaglandin synthesis, amino acid transport, detoxification of toxins and carcinogens, enhancement of the immune system, and protection from oxidation and enzyme activations. Glutathione has strong antiviral properties. If there are higher levels of glutathione in the tissues and serum, then the replication of most pathogens are stopped. Conversely, if the levels of glutathione are low, then conditions become much more favourable for viruses.
6.9.2 Coenzyme Q10

Coenzyme Q10 (also known as ubiquinone, ubidecarenone, coenzyme Q, CoQ10, CoQ, Q10, or simply Q) is a benzoquinone, where Q refers to the quinone chemical group, and 10 refers to the isoprenyl chemical subunits. It is an oil-soluble vitamin-like substance is present in most eukaryotic cells, primarily in the mitochondria. It is a component of the electron transport chain and participates in aerobic cellular respiration, generating energy in the form of ATP. Ninety-five percent of the human body's energy is generated this way. Therefore, those organs with the highest energy requirements, such as the heart and the liver, have the highest CoQ 10 concentrations.

Because of its ability to transfer electrons, coenzyme Q10 acts as an antioxidant and is taken as a nutrient for its antioxidant properties.
6.9.3 Para-amino Benzoic Acid (PABA)

PABA is an antioxidant, and necessary for the metabolism of amino acids. It is also linked to red blood cell formation and assisting in the manufacture of folic acid in the intestines. PABA has also been linked to hair growth and pigmentation.

6.10 Chondroitin

Chondroitin is a natural substance found in the body. It is believed to help draw water and nutrients into the cartilage, keeping it spongy and healthy. Chondroitin is available as chondroitin sulphate supplement, which are made from bovine or shark cartilage.

6.11 Glucosamine

Glucosamine is a sugar naturally produced by the body. It is one of the building blocks of cartilage.

Glucosamine comes in at least two forms: glucosamine sulphate and glucosamine hydrochloride. Glucosamine supplements are made from crab, lobster or shrimp shells.

Often chondroitin and glucosamine are taken in combination.

6.12 Inositol (Previously Vitamin B8)

Inositol is a carbocyclic polyol that plays an important role as the structural basis for a number of secondary messengers in eukaryotic cells. The previous name for inositol was vitamin B8 but it is no longer classified as a vitamin after it was discovered that inositol is synthesised in the human body.

Inositol plays an important part in the health of cell membranes especially the specialized cells in the brain, bone marrow, eyes and intestines.

Inositol is said to promote healthy hair, hair growth, and helps in controlling estrogen levels and may assist in preventing breast lumps. It may also be of benefit in reducing blood cholesterol levels, and in the treatment of depression or panic disorders.

Deficiency of inositol may lead to eczema, hair loss, constipation, and abnormalities of the eyes and raised cholesterol.

6.13 Lecithin

Lecithin is any of a group of yellow-brownish fatty substances occurring in animal and plant tissues, and in egg yolk, composed of phosphoric acid, choline, fatty acids, glycerol, glycolipids, triglycerides, and phospholipids (e.g., phosphatidylcholine, phosphatidylethanolamine, and phosphatidylinositol).

6.14 Laetrile (Vitamin B17)

Laetrile (or amygdalin), although called a vitamin is not generally recognised as such.

It has been suggested that laetrile may prevent the growth of cancers, reduce blood pressure, and the pain associated with arthritis.

6.15 Orotic Acid (Vitamin B13)

Orotic acid is no longer recognised as a vitamin as it is produced by the body. It assists in the metabolism of folic acid and vitamin B12, and assists in the absorption of nutrients including calcium and magnesium.

It also helps in the production of genetic material.

It is believed that orotic acid may be beneficial after a heart attack, and has been used in conditions such as multiple sclerosis and chronic hepatitis. It has also been reported that it can prevent liver-related complications and premature aging.

6.16 Pangamic Acid (Vitamin B15)

Pangamic acid is not currently recognised as a vitamin because its essential requirement in the diet has not yet been proven.

Research suggests that it may assist in the lowering of cholesterol blood levels and aid in protein synthesis. It is water-soluble.

It has been used to treat cancer, schizophrenia, and heart disease.

6.17 Phylloquinone (Vitamin K)

Vitamin K is not generally recognised as a vitamin because it can be produced in the intestines. Two naturally occurring forms: vitamin K1 (phylloquinone) and vitamin K2 (menaquinone) exist, and a third synthetic form: vitamin K3 (menadione) also exists.

Vitamin K is used in the body to control blood clotting. It also assists in the conversion of glucose to glycogen for storage in the liver.

There are some indications that vitamin K may be involved in bone formation and repair, and may be used to decrease the incidence or severity of osteoporosis and slow bone loss.

Vitamin K is fat-soluble.

6.18 Preparing the Formulations

A person skilled in the art will appreciate that the amount or volume of each medicinal supplement in the formulation will need to be determined based on a number of factors, including the solubility of the medicinal supplement, the stability of the medicinal supplement, the prescribed or recommended dosage of the medicinal supplement, any limitations on the amount or volume of the medicinal supplement that an individual can take, any known interactions between different medicinal supplements (or interactions with one or more nutritional supplements) and other factors known to a person skilled in the art.

A person skilled in the art will appreciate that the amount or volume of each nutritional supplement will need to be determined based on a number of factors, including the solubility of the nutritional supplement (e.g. water-soluble vitamins and fat-soluble vitamins), the stability of the nutritional supplement, the dietary reference intake (DRI), recommended daily intake (RDI) or recommended dietary allowance (RDA) of the nutritional supplement or any other measure of an appropriate or recommended dosage, any limitations on the amount or volume of the nutritional supplement that an individual can take including consideration of safe and adequate intake/range (or estimate thereof), any known interactions between different nutritional supplements (or interactions with one or more medicinal supplements) and other factors known to a person skilled in the art.

A person skilled in the art will also appreciate that the amount or volume of each medicinal supplement and/or nutritional supplement in the formulation may be determined taking into account that the consumer may ingest one or more unit dose(s) of formulation (for example, one or more containers may be used). Where the consumer ingests more than one unit dose of formulation, this may be at the same time or at different times (for example, morning and evening). The formulation may also be prepared in unit doses that permit different consumers to ingest a different number of unit doses, for example, taking into account the different ages, weights, or health conditions of different consumers. In exemplary embodiments; the formulation may be prepared in a unit dose that permits a certain number of unit doses to be taken by a child (i.e. paediatric dosage) and a different number of unit dosages to be taken by an adult (i.e. adult dosage).

The formulations used in the present invention are in liquid form which allows for higher absorbance compared to solid forms such as tablets. In some embodiments, the invention may comprise a container comprising a liquid formulation, wherein the liquid formulation is freeze-dried. The liquid formulation may be freeze-dried to permit enhanced ease for packaging, transporting and storage of the containers comprising the formulation.

When considering the solubility of the ingredients for the formulation, various solvents may be considered including propylene glycol and water. A person skilled in the art will know that some ingredients are water-soluble (e.g. all B vitamins and vitamin C) and others are fat-soluble (e.g. vitamins A and E). In preparing the formulation, one skilled in the art will recognise the need to ensure all ingredients are adequately dissolved, solubilised or suspended in solution in order to produce a liquid formulation.

In some embodiments, the present invention contemplates formulations comprising either one or more water-soluble ingredients, or one or more fat-soluble ingredients, or a mixture of one or more water-soluble ingredients and one or more fat-soluble ingredients.

The formulations are formulated for ingestion.

In some embodiments, the formulations are formulated for addition to a food or a beverage prior to ingestion. In specific embodiments, the containers, strips or packages of the present invention are intended to be sold without the food or beverage to which they are to be added.

In specific embodiments, the formulation does not significantly alter the taste and/or aroma of the food or beverage to which it is added.

The food or beverage may be a hot food or a hot beverage, including but not limited to food or beverage at a temperature greater than 55° C., 60° C., 65° C., 70° C., or 75° C., more preferably a food or beverage at a temperature at a temperature greater than 85° C., 90° C., or 95° C.

The formulation may comprise a bitter-tasting vitamin. In specific embodiments, the formulations are formulated for addition to a bitter food or a bitter beverage.

Exemplary foods to which the formulations may be added include, but are not limited to breakfast cereals, yoghurts, or smoothies.

Exemplary beverages to which the formulations may be added include, but are not limited to fruit juices, milk, coffee, tea, or beer.

6.19 Flavouring Agents

In some embodiments, the formulation is substantially free of any flavouring agent selected from the group consisting of sucrose, glucose, fructose, galactose, lactose, glutamic acid, monosodium L-glutamate, monopotassium L-glutamate, calcium di-L-glutamate, monoammonium L-glutamate, magnesium di-L-glutamate, guanylic acid, disodium guanylate, dipotassium guanylate, calcium guanylate, inosinic acid, disodium inosinate, dipotassium inosinate, calcium inosinate, calcium 5′-ribonucleotides, disodium 5-ribonucleotide, sodium 5-ribonucleotide, maltol, and ethyl maltol.

As used herein, the term “substantially free” means less than 5%, 4%, 3%, 2%, 1%, 0.1%, 0.01%, or 0.001% and any percentages inbetween.

Flavouring agents are typically used to mask unpleasant or undesirable tastes in medicinal supplements and/or nutritional supplements. Flavouring agents may also be used to mask unpleasant or undesirable aromas (or odours) in medicinal supplements and/or nutritional supplements.

However, where formulations are formulated for addition to a food or a beverage prior to ingestion, such flavouring agents can interfere with the taste and/or aroma of the food or beverage to which they are added. This interference can make the food or beverage less desirable to the consumer. Consumers, for example, can be very particular about the taste and aroma of the coffee they drink, and do not want interference to this taste and aroma. As a result of using flavouring agents, reduced or no compliance may occur because the consumer is reluctant to ingest the food or beverage with the altered taste and/or aroma. Sucrose, for example, sweetens a food or beverage which may be undesirable to the consumer.

Furthermore, in some instances, flavouring agents can have an affect on the consumer. Sucrose, for example, leads to higher blood sugar levels which may be undesirable to consumers who want to lose weight, and potentially even more damaging to consumers with diabetes. Additionally, some consumers cannot tolerate some flavouring agents, including for example, having allergies to the flavouring agents.
6.19.1 Sucrose, Fructose, Galactose and Lactose

These four sugars are all used as sweetening agents but are not always desirable in a product formulated for ingestion. Studies have indicated potential links between processed sugar consumption and health hazards, including obesity, tooth decay and coronary heart disease. Individuals with diabetes are unable to metabolise some sugars properly.
6.19.2 Glutamic Acid (E-number: 620 or E620)

Glutamic acid is an amino acid that can be obtained from many animal proteins, vegetable proteins, and bacteria. It is thought that glutamic acid may cause similar problems as monosodium glutamate (E621), and it is believed that young children should avoid ingesting this amino acid. It is also believed that this amino acid may kill nerve cells, resulting in diseases such as Huntington's disease, Alzheimer's disease and Parkinson's disease.
6.19.3 Monosodium L-glutamate (E-number: 621 or E621)

Monosodium L-glutamate (also known as monosodium glutamate or MSG) is the sodium salt of glutamic acid. Although used as a flavour enhancer in a large number of food and beverage products, it appears to have an adverse effects in some peoplewith asthma, and it is believed that it should not be permitted in foods for infants and young children as it may damage the nervous system resulting in diseases such as Huntington's disease, Alzheimer's disease and Parkinson's disease. Pregnant women, children, people who are hypoglycaemic, the elderly and those with heart disease are at risk from reactions to monosodium L-glutamate.
6.19.4 Monopotassium L-glutamate (E-number: 622 or E622)

Monopotassium L-glutamate is the potassium salt of glutamic acid. It is often used as a low sodium salt substitute in food and beverage products. However, it can cause nausea, vomiting, diarrhoea, and abdominal cramps. Monopotassium L-glutamate is not suitable for babies under 12 months old or those people with impaired kidneys.
6.19.5 Calcium di-L-glutamate (E-number: 623 or E623)

Calcium di-L-glutamate is used as a salt substitute in food and beverage products. Although there are no known adverse effects to this product, it may present problems for asthmatics and aspirin sensitive people.
6.19.6 Monoammonium L-glutamate (E-number: 624 or E624)

Monoammonium L-glutamate is used as a salt substitute and flavour enhancer in food and beverage products. No known adverse effects.
6.19.7 Magnesium di-L-glutamate (E-number: 625 or E625)

Magnesium di-L-glutamate is used as a salt substitute and flavour enhancer in food and beverage products. No known adverse effects.
6.19.8 Guanylic Acid (E-number: E626)

Guanylic acid and guanylates should be avoided by asthmatics.
6.19.9 Disodium Guanylate (E-number: 627 or E627)

Disodium guanylate is used as a flavour enhancer in food and beverage products. Disodium guanylate is not not permitted in food and beverage products for infants and young children. As guanylates are metabolised to purines, they should be avoided by people suffering from gout. Furthermore, people with hyperactivity, asthma and aspirin sensitivity should also avoid it.
6.19.10 Dipotassium Guanylate (E-number: E628)

Dipotassium guanylate is used as a flavour enhancer in foo.d and beverage products. As guanylates are metabolised to purines, they should be avoided by people suffering from gout. They should also be avoided by asthmatics, and may not be used in products intended for children under 12 weeks.
6.19.11 Calcium Guanylate (E-number: E629)

Calcium guanylate is used as a flavour enhancer in food and beverage products. As guanylates are metabolised to purines, they should be avoided by people suffering from gout. They should also be avoided by asthmatics, and may not be used in products intended for children under 12 weeks.
6.19.12 Inosinic Acid (E-number: E630)

Inosinic acid is used in many food and beverage products but should be avoided by asthmatics. Further, as inosinates are metabolised to purines, they should be avoided by people suffering from gout.

Inosinates are generally produced from meat, but partly also from fish. Therefore they are generally not suitable for vegans and vegetarians, and in most cases not suitable for Jews, Muslims and Hindus, depending on the origin of the product.
6.19.13 Disodium Inosinate (E-number: 631 or E631)

Disodium inosinate is used as a flavour enhancer in food and beverage products and is not permitted in foods for infants and young children, and should be avoided by those with gout and asthma.

Inosinates are generally produced from meat, but partly also from fish. Therefore they are generally not suitable for vegans and vegetarians, and in most cases not suitable for Jews, Muslims and Hindus, depending on the origin of the product.
6.19.14 Dipotassium Inosinate (E-number: E632)

Dipotassium inosinate is used as a flavour enhancer in food and beverage products and is not permitted in foods for infants and young children, and should be avoided by those with gout and asthma.

Inosinates are generally produced from meat, but partly also from fish. Therefore they are generally not suitable for vegans and vegetarians, and in most cases not suitable for Jews, Muslims and Hindus, depending on the origin of the product.
6.19.15 Calcium Inosinate (E-number: E633)

Calcium inosinate is used as a flavour enhancer in food and beverage products and is not permitted in foods for infants and young children, and should be avoided by those with gout and asthma.

Inosinates are generally produced from meat, but partly also from fish. Therefore they are generally not suitable for vegans and vegetarians, and in most cases not suitable for Jews, Muslims and Hindus, depending on the origin of the product.
6.19.16 Calcium 5′-riboncleotides (E-number: E634)

This comprises at least one of: calcium 5′-inosinate, calcium 5′-guanylate, calcium 5′-cytidylate, and calcium 5′-uridylate, and is used as a flavour enhancer in many products including low sodium or salt products.

Asthmatic people should avoid this product as they should avoid guanylates and inosinates. Furthermore, as guanylates and inosinates are metabolised to purines, they should be avoided by people suffering from gout.
6.19.17 Disodium 5′-ribonucleotide (E-number: 635 or E635)

Disodium 5′-ribonucleotide may be associated with itchy skin rashes, and should be avoided by those with gout or asthma, and those with aspirin sensitivity.
6.19.18 Sodium 5′-ribonucleotide (E-number: E635)

Sodium 5′-ribonucleotide may be associated with itchy skin rashes, and should be avoided by those with gout or asthma, and those with aspirin sensitivity.
6.19.19 Maltol (E-number: 636 or E636)

Maltol is an artificial sweetener and flavour enhancer used in many products. In large quantities maltol can help aluminium pass into the brain to cause Alzheimer's disease. It should be avoided by vegans as it is sometimes derived from cow's milk. In some countries malton is banned in food and beverage products for babies and young children.
6.19.20 Ethyl Maltol (E-number: 637)

Ethyl maltol is chemically derived from maltol and is used as a base for essences, as a synthetic artificial flavour and as a flavour enhancer. Sometimes it is derived from cow's milk and it therefore should be avoided by vegans. In some countries ethyl maltol is banned ban in food and beverage products for babies and young children.

6.20 Preservatives

In some embodiments, the formulation is substantially free of any preservative selected from the group consisting of ammonia, benzoic acid, sodium benzoate, potassium benzoate, calcium benzoate, ethyl para-hydroxybenzoate, sodium ethyl para-hydroxybenzoate, propylparaben, sodium propyl para-hydroxybenzoate, methylparaben, sodium methyl p-hydroxybenzoate, sulphur dioxide, sodium sulphite, sodium bisulphite, sodium metabisulphite, potassium metabisulphite, potassium sulphite, calcium sulphite, calcium hydrogen sulphite, potassium bisulphite, biphenyl, orthophenyl phenol, sodium orthophenyl phenol, thiabendazole, nisin, natamycin, formic acid, sodium formate, calcium formate, hexamethylene tetramine, formaldehyde, dimethyl dicarbonate, potassium nitrite, sodium nitrite, sodium nitrate, potassium nitrate, acetic acid, potassium acetate, sodium acetate, sodium diacetate, calcium acetate, ammonium acetate, lactic acid, propionic acid, sodium propionate, calcium propionate, potassium propionate, boric acid, sodium tetraborate, carbon dioxide, lysozyme, and EDTA.

As used herein, the term “substantially free” means less than 5%, 4%, 3%, 2%, 1%, 0.1%, 0.01%, or 0.001% and any percentages inbetween.

Preservatives are typically used to stabilise or prevent degradation of medicinal supplements and/or nutritional supplements.

However, some consumers cannot tolerate some preservatives, including for example, allergies to lactose or to other preservatives.

Furthermore, some consumers do not like the idea of having additional ingredients in their products, and therefore despite no known allergy or otherwise to the preservative, will not take the formulation due to the presence of preservatives in the formulation, thus reducing their compliance.
6.20.1 Ammonia

Ammonia is used as a preservative agent in food and beverage products.
6.20.2 Benzoic Acid (E-number: 210 or E210)

Also known as flowers of benzoin, phenlycarboxylic acid, and carboxybenzene. It is used as a preservative agent in many food and beverage products.

Benzoic acid can cause asthma, especially in those dependant on steroid asthma medications. Is also reputed to cause neurological disorders and to provoke hyperactivity in children.
6.20.3 Sodium Benzoate (E-number: 211 or E211)

Sodium benzoate is the sodium salt of benzoic acid, and is used as a preservative agent in many food and beverage products.

It is known to cause nettle rash and aggravate asthma. It is also suspected to be a neurotoxic hazard.
6.20.4 Potassium Benzoate (E-number: 212 or E212)

Potassium benzoate is the potassium salt of benzoic acid, also used as a preservative agent. People with a history of allergies may show allergic reactions to potassium benzoate.
6.20.5 Calcium Benzoate (E-number: 213 or E213)

Calcium benzoate is the calcium salt of benzoic acid, used as a preservative agent, particularly in fruit juice.
6.20.6 Ethyl Para-hydroxybenzoate (E-number: E214)

Ethyl para-hydroxybenzoate is a derivative of benzoic acid, and is used as a preservative agent in food and beverage products.
6.20.7 Sodium Ethyl Para-hydroxybenzoate (E-number: E215)

This is the sodium salt of ethyl para-hydroxybenzoate, and is sometimes used as a preservative agent but is now banned in Australia.
6.20.8 Propylparaben (E-number: 216 or E216)

Propylparaben (also known as propyl para-hydroxybenzoate) is a preservative agent used in food and beverage products. It may be a contact allergen for some people, and is potentially dangerous to asthmatics.
6.20.9 Sodium Propyl Para-hydroxybenzoate (E-number: E217)

This is the sodium salt of propyl para-hydroxybenzoate, used as a preservative agent. Sodium propyl para-hydroxybenzoate may cause irritation to sensitive skin.
6.20.10 Methylparaben (E-number: 218)

Also known as methyl para-hydroxybenzoate, this preservative agent is a possible contact allergen.
6.20.11 Sodium Methyl P-hydroxybenzoate (E-number: 219 or E219)

The sodium salt of E218, sodium methyl para-hydroxybenzoate is primarily an antifungal agent. May cause irritation to the skin.
6.20.12 Sulphur Dioxide (E-number: 220 or E220)

Sulphur dioxide is used as a preservative agent. All sulphur drugs are toxic and restricted in use. Sulphur dioxide is known to provoke gastric irritation, nausea, diarrhoea, skin rash, asthma attacks and is difficult for those with impaired kidney function to metabolise. Sulphur dioxide also destroys vitamin B1, and should be avoided by anyone suffering from conjunctivitis, bronchitis, emphysema, bronchial asthma, or cardiovascular disease.
6.20.13 Sodium Sulphite (E-number 221 or E221)

Although this is a preservative agent, it is not suitable for all food or beverage products as it destroys vitamin B1. Over exposure to sodium sulphite may cause an asthmatic attack, or cause gastric irritation.
6.20.14 Sodium Bisulphite (E-number: 222 or E222)

Sodium bisulphite (also called sodium hydrogen sulphite) is used as a preservative agent, but may induce asthma attacks, or cause gastric irritation. It also destroys vitamin B1.
6.20.15 Sodium Metabisulphite (E-number: 223 or E223)

Also known as pyrosulphurous acid or disodium salt, this is used as a preservative agent in food and beverage products.
6.20.16 Potassium Metabisulphite (E-number: 224 or E224)

Also known potassium pyrosulfite and pyrosulfurous acid dipotassium salt. this is used as a preservative agent in food and beverage products.
6.20.17 Potassium Sulphite (E-number: 225 or E225)

Used as a preservative agent in food and beverage products, this has similar undesirable effects to sulphur dioxide.
6.20.18 Calcium Sulphite (E-number: 226 or E226)

Used as a preservative agent in food and beverage products.
6.20.19 Calcium Hydrogen Sulphite (E-number: 227 or E227)

Used as a preservative agent in food and beverage products.
6.20.20 Potassium Bisulphite (E-number: 228 or E228)

Also known as potassium hydrogen sulphite, this is used as a preservative agent in food and beverage products, this has similar undesirable effects to sulphur dioxide.
6.20.21 Biphenyl (E-number: 230 or E230)

Also known as diphenyl, this is a preservative agent.
6.20.22 Orthophenyl Phenol (E-number: 231 or E231)

Used as a preservative agent.
6.20.23 Sodium Orthophenyl Phenol (E-number: 232 or E232)

Used as a preservative agent.
6.20.24 Thiabendazole (E-number: 233 or E233)

Thiabendazole is used as a preservative in food and beverage products, but can cause anorexia, nausea, vomiting, and vertigo.
6.20.25 Nisin (E-number: 234 or E234)

Used in food and beverage products as a preservative agent.
6.20.26 Natamycin (E-number: 235 or E235)

Also known as pimaracin, this is used as a preservative agent but can cause nausea, vomiting, anorexia, diarrhoea and skin irritation.
6.20.27 Formic Acid (E-number: 236 or E236)

Formic acid is used as a preservative agent.
6.20.28 Sodium Formate (E-number: E237)

Used as a preservative agent, but also has diuretic properties.
6.20.29 Calcium Formate (E-number: E238)

Used as a preservative agent, but also has diuretic properties.
6.20.30 Hexamethylene Tetramine (E-number: E239)

Also known as hexamine, this is a preservative agent but may result in stomach upsets if prolonged ingestion occurs. It may also be carcinogenic.
6.20.31 Formaldehyde (E-number: E240)

Also known as formalin, formic aldehyde, methylene oxide, oxomethane, paraform.

Formaldehyde is used to preserve some food products, but is known to cause bums, and to be toxic by inhalation, ingestion and through skin absorption. It is a mutagen and may also be a carcinogen. It may cause damage to kidneys, and may cause allergic reactions, sensitisation, and heritable genetic damage. Formaldehyde is a lachrymator. It is also very destructive of mucous membranes and upper respiratory tract, eyes and skin.
6.20.32 Dimethyl Dicarbonate (E-number: 242 or E242)

Used as a preservative agent.
6.20.33 Potassium Nitrite (E-number: 249 or E249)

Potassium nitrite is used as a preservative agent in some food and beverage products. Excessive ingestion may result in shortness of breath, dizziness and headaches. It may also form nitrosamines in the stomach, thought to be carcinogenic agents. It is not permitted in foods for infant and young children.
6.20.34 Sodium Nitrite (E-number: 250 or E250)

Sodium nitrite is used as a preservative agent, but is toxic and may be fatal if swallowed. It is also an eye, skin and respiratory irritant. It may also be a carcinogen, may provoke hyperactivity and other adverse reactions. The use of sodium nitrite as a preservative is restricted in many countries.
6.20.35 Sodium Nitrate (E-number: 251 or E251)

Also known as saltpetre and cubic nitre, this is used as a preservative but is harmful if swallowed or inhaled. It is also a skin, eye and respiratory irritant.
6.20.36 Potassium Nitrate (E-number: 252 or E252)

Potassium nitrate is used as a preservative in food products. It may cause reproductive disorders, provoke hyperactivity and other adverse reactions, and is potentially carcinogenic. Its use is restricted in many countries.
6.20.37 Acetic Acid (E-number: 260 or E260)

Acetic acid (ethanoic acid) is used as a food and beverage product preservative. Acetic acid is strongly corrosive and causes serious burns, as well as being a lachrymator.
6.20.38 Potassium Acetate (E-number: 261 or E261)

Potassium acetate should be avoided by people with impaired kidney function. It may also irritate the skin, eyes and lungs.
6.20.39 Sodium Acetate (E-number: 262 or E262)

Sodium acetate is used as a preservative agent.
6.20.40 Sodium Diacetate:

Sodium diacetate (sodium hydrogen acetate) is used as a preservative agent.
6.20.41 Calcium Acetate (E-number: 263 or E263)

Calcium acetate is used as a preservative agent in food and beverage products. It may cause eye, skin or respiratory irritation, and mutagenic effects have been noted in laboratory tests.
6.20.42 Ammonium Acetate (E-number: 264 or E264)

This preservative agent can cause nausea and vomiting.
6.20.43 Lactic Acid (E-number: 270 or E270)

While lactic acid has no known side effects in adults, some, forms should not be given to babies and small children, as they have not yet developed the appropriate enzymes to metabolise these forms.
6.20.44 Propionic Acid (E-number: 280 or E280)

While used as a preservative agent, all propionates are thought to be linked with migraine headaches.
6.20.45 Sodium Propionate (E-number: 281 or E281)

Sodium propionate is a preservative agent, believed to be linked to migraines.
6.20.46 Calcium Propionate (E-number: 282 or E282)

Calcium propionate is a preservative agent, believed to be linked to migraines.
6.20.47 Potassium Propionate (E-number: 283 or E283)

Potassium propionate is a preservative agent, believed to be linked to migraines.
6.20.48 Boric Acid (E-number: E284)

Boric acid is a preservative agent but is suspected to be a neurotoxic hazard. Ingestion is harmful and may be fatal. It is also an irritant and may cause congenital malformation in the fetus. It may also cause reproductive disorders.
6.20.49 Sodium Tetraborate (E-number: E285)

Also known as borax, this may cause reproductive disorders. It is also an . eye and skin irritant and is harmful by ingestion.
6.20.50 Carbon dioxide (E-number: 290 or E290)

Carbon dioxide is used as a preservative agent in food and beverage products. It is suspected of being a neurotoxic hazard.
6.20.51 Lysozyme (E-number: E1105)

Also known as muramidase or N-acetylmuramide glycanhydrolase, these are a family of enzymes:
6.20.52 Ethylenediaminetetraacetic Acid (E-number: E385)

Also known as EDTA, this is produced as several salts, notably disodium EDTA and calcium disodium EDTA.

7. Systems and methods of enhancing compliance

The present invention also provides compliance enhancing systems comprising packages and strips of the present invention, wherein the packages and strips are labeled to indicate that the containers are to be used in conjunction with an existing routine.

In specific embodiments, the compliance enhancing system comprises packages or strips that are labeled to indicate that the formulation within each container is to be added to a beverage or food taken as part of an existing routine.

The present invention also provides methods of enhancing compliance in a consumer. The method may comprise providing a consumer with a container, a strip, or a package of the present invention, wherein the container, strip, or package is optionally labeled to indicate that the formulation within the container or each container is to be added to a food or beverage that is taken as part of an existing routine, the formulation being dispensing into the food or beverage either by or on behalf of the consumer, the consumer then ingesting the food or beverage containing the formulation. In some embodiments, the method comprises providing a consumer with a container, a strip, or a package of the present invention, wherein the container, strip, or package is optionally labeled to indicate that the formulation within the container or each container is to be added to a food or beverage that is taken as part of an existing routine, the consumer dispensing the formulation into the food or beverage, the consumer then ingesting the food or beverage containing the formulation. In alternative embodiments, the method comprises providing a consumer with a container, a strip, or a package of the present invention, wherein the container, strip, or package is optionally labeled to indicate that the formulation within the container or each container is to be added to a food or beverage that is taken as part of an existing routine, providing the consumer with the food or beverage, wherein the formulation is dispensed into the food or beverage. The consumer may then ingest the food or beverage containing the formulation. Suitably, the consumer or the person providing the formulation and/or food or beverage dispenses the formulation into the food or beverage. Examples of these embodiments include a retail outlet selling the food or beverage which,also offers the consumer the option of ordering a formulation to be ingested in conjunction with the food or beverage. For example, a consumer may purchase a coffee from a coffee vendor as part of an existing routine (e.g., morning coffee) and also purchase a formulation to be dispensed into the coffee so that the ingested coffee contains added nutritional benefits by way of the formulation.

These aspects are based not only on the discovery that a key factor in improving patient compliance is to remove factors of the system that contribute to non-compliance, but also to create a link in the consumer's mind between ingesting the formulation held within the container and an existing routine the consumer already performs. It is believed that making this link shifts the act of taking the formulation as a separate act that needs to be remembered and actioned, to something done as a matter of habit.

Existing routines include daily routines, including, but not limited to a meal time such as breakfast, lunch, dinner, or otherwise, or another routine such as a habitual morning cup of coffee or tea, walking the dog, or evening tea or hot chocolate.

Labelling the packages and strips can assist in creating this link in the consumer's mind. The labelling may be as herein described, and may comprise text, images, or text and images and may be achieved by engraving, embossed text, graduations in the mold, or by attachment of a label to the surface of the container, or any other suitable labelling method known in the art.

The labelling may be anywhere on the container, strip of containers or packaging where it is visible to the consumer who is to dispense the formulation from the container for ingestion (typically the consumer, but may also be a carer if the formulation is to be taken by a child or other person who requires assistance). In specific embodiments, the label is at an end of each single-use container.

In some embodiments, the container, strip, or package may be labeled as described herein. In some embodiments, a container or strip may be used where the container or strip that is used or provided to the consumer is not labeled but the package comprising the container or strip is labeled as described herein. In some embodiments, a container may be used where the container that is used or provided to the consumer is not labeled but the package or strip comprising the container is labeled as described herein.

In order that the invention may be readily understood and put into practical effect, specific embodiments will now be described by way of the following non-limiting examples.

### EXAMPLES

### Specific Formulations

Examples 1-13 are examples of specific formulations proposed for use in the present invention.

In these examples, it is proposed that the formulation is prepared so that each 1 mL contains the amounts of each ingredient as described below. However, it is envisaged that larger volumes of the nutritional supplement be prepared at one time and smaller volumes (preferably 1 ml) be dispensed into single-use containers to provide individual packaged unit doses of the formulation.

### Example 1—Multivitamin for Men

Each 1 mL contains the following ingredients mixed in water made up to the volume. Further ingredients may be added to facilitate the dissolution of one or more of these ingredients.

| Ingredient | Amount | |
|---|---|---|
| Beta-carotene | 5 | mg |
| Vitamin B1 as thiamin mononitrate | 5-50 | mg |
| Vitamin B2 | 1-30 | mg |
| Vitamin B3 as niacinamide | 5-40 | mg |
| Vitamin B5 as calcium d-pantothenate | 1-10 | mg |
| Vitamin B6 as pyridoxine hydrochloride | 10-50 | mg |
| Vitamin B7 | 300 | mcg |
| Vitamin B9 as folic acid | 400 | mcg |
| Vitamin B12 | 5-40 | mcg |
| Chloride as potassium chloride | 17 | mg |
| Chromium as chromium amino acid chelate | 120 | mcg |
| Copper as cupric gluconate | 2 | mg |
| Magnesium as magnesium oxide | 30-150 | mg |
| Manganese as manganese amino acid chelate | 2 | mg |
| Molybdenum as molybdenum amino acid chelate | 75 | mcg |
| Potassium as potassium chloride | 17 | mg |
| Selenium as selenium amino acid chelate | 10-70 | mcg |
| Zinc as zinc oxide | 5-30 | mg |
| Saw palmetto (Serenoa repens) (fruit) | 50 | mg |

Store at room temperature between 15-30 degrees away from light and moisture. Keep away from children.

### Example 2—Multivitamin for Women

Each 1 mL contains the following ingredients mixed in water, made up to the volume. Further ingredients may be added to facilitate the dissolution of one or more of these ingredients.

| Ingredient | Amount | |
|---|---|---|
| Beta-carotene | 5 | mg |
| Vitamin B1 as thiamin mononitrate | 5-50 | mg |
| Vitamin B2 | 1-30 | mg |
| Vitamin B3 as niacinamide | 5-40 | mg |
| Vitamin B5 as calcium d-pantothenate | 1-10 | mg |
| Vitamin B6 as pyridoxine hydrochloride | 10-50 | mg |
| Vitamin B7 | 300 | mcg |
| Vitamin B9 as folic acid | 400 | mcg |
| Vitamin B12 | 5-40 | mcg |
| Chloride as potassium chloride | 17 | mg |
| Chromium as chromium amino acid chelate | 120 | mcg |
| Copper as cupric gluconate | 2 | mg |
| Magnesium as magnesium oxide | 30-150 | mg |
| Manganese as manganese amino acid chelate | 2 | mg |
| Molybdenum as molybdenum amino acid chelate | 75 | mcg |
| Potassium as potassium chloride | 17 | mg |
| Selenium as selenium amino acid chelate | 10-70 | mcg |
| Zinc as zinc oxide | 5-30 | mg |

Store at room temperature between 15-30 degrees away from light and moisture. Keep away from children.

### Example 3—Cold and Flu

Each 1 mL contains the following ingredients mixed in water made up to the volume. Further ingredients may be added to facilitate the dissolution of one or more of these ingredients.

| Ingredient | Amount | |
|---|---|---|
| Digestive enzymes (protease, lipase and amylase) | 100 | mg |
| Zinc gluconate | 15-75 | mg |
| Cat's claw (Uncaria tomentose) | 50-250 | mg |
| Echinacea (Echinacea purpura) | 150-500 | mg |
| Gotu kola (Centella Asiatica) | 50-100 | mg |

Store at room temperature between 15-30 degrees away from light and moisture. Keep away from children.

### Example 4—Executive B Complex

Each 1 mL contains the following ingredients mixed in water made up to the volume. Further ingredients may be added to facilitate the dissolution of one or more of these ingredients.

| Ingredient | Amount | |
|---|---|---|
| Vitamin B1 as thiamin mononitrate | 75 | mg |
| Vitamin B2 | 10 | mg |
| Vitamin B3 as nicotinamide | 100 | mg |
| Vitamin B5 as calcium pantothenate | 75 | mg |
| Vitamin B6 as pyridoxine hydrochloride | 25 | mg |
| Vitamin B7 | 20 | mcg |
| Vitamin B9 as folic acid | 150 | mcg |
| Vitamin B12 | 30 | mcg |
| Choline bitartrate | 25 | mg |
| Calcium phosphate | 100 | mg |
| Magnesium phosphate | 140 | mg |
| Potassium phosphate monobasic | 117.3 | mg |
| Oats (Avena sativa) extract equiv. to dry seed | 250 | mg |
| Passion flower (Passiflora incarnate) extract | 100 | mg |
| Inositol | 25 | mg |
| Lecithin | 50 | mg |

Store at room temperature between 15-30 degrees away from light and moisture. Keep away from children.

### Example 5—Antistress Complex

Each 1 mL contains the following ingredients mixed in water made up to the volume. Further ingredients may be added to facilitate the dissolution of one or more of these ingredients.

| Ingredient | Amount | |
|---|---|---|
| Vitamin A | 500 | IU |
| Vitamin B1 | 50 | mg |
| Vitamin B2 | 50 | mg |
| Vitamin B3 | 75 | mg |
| Vitamin B5 as calcium d-pantothenate | 250 | mg |
| Vitamin B6 | 50 | mg |
| Vitamin B7 | 300 | mcg |
| Vitamin B9 as folic acid | 600 | mcg |
| Vitamin B12 | 250 | mcg |
| Vitamin C as magnesium ascorbate | 20 | mg |
| Vitamin E as d-alpha tocopheryl succinate | 30 | IU |
| Choline bitartrate | 50 | mg |
| Magnesium aspartate | 100 | mg |
| Barley grass | 75 | mg |
| Bioflavonoid complex (50% flavanones) | 100 | mg |
| Chlorella (broken cell) | 75 | mg |
| Hops flower (Humulus lupulus) with 0.4% flavonoids | 50 | mg |
| Passion flower (Passiflora incarnate) herb | 25 | mg |
| Spirulina | 50 | mg |
| Inositol (hexaphosphate) | 50 | mg |

Store at room temperature between 15-30 degrees away from light and moisture. Keep away from children.

### Example 6—High Energy Guarana

Each 1 mL contains the following ingredients mixed in water made up to the volume. Further ingredients may be added to facilitate the dissolution of one or more of these ingredients.

| Ingredient | Amount | |
|---|---|---|
| Taurine | 100 | mg |
| Vitamin B1 as thiamine hydrochloride | 5 | mg |
| Vitamin B2 | 2 | mg |
| Vitamin B3 as nicotinamide | 8 | mg |
| Vitamin B5 as calcium pantothenate | 2 | mg |
| Vitamin B6 as pyroxidine hydrochloride | 5 | mg |
| Vitamin B7 | 20 | mcg |
| Vitamin B9 as folic acid | 150 | mcg |
| Vitamin B12 | 30 | mcg |
| Calcium phosphate | 10 | mg |
| Magnesium phosphate | 10 | mg |
| Potassium phosphate monobasic | 5 | mg |
| Guarana extract | 300 | mg |
| Inositol (hexaphosphate) | 50 | mg |

Store at room temperature between 15-30 degrees away from light and moisture. Keep away from children.

### Example 7—Antioxidant

Each 1 mL contains the following ingredients mixed in water made up to the volume. Further ingredients may be added to facilitate the dissolution of one or more of these ingredients.

| Ingredient | Amount | |
|---|---|---|
| Vitamin B1 as thiamine hydrochloride | 5 | mg |
| Vitamin B2 | 2 | mg |
| Vitamin B3 as nicotinamide | 8 | mg |
| Vitamin B5 as calcium pantothenate | 2 | mg |
| Vitamin B6 as pyroxidine hydrochloride | 5 | mg |
| Vitamin B7 | 20 | mcg |
| Vitamin B12 | 30 | mcg |
| Magnesium phosphate | 10 | mg |
| Curcumin | 300 | mg |

Store at room temperature between 15-30 degrees away from light and moisture. Keep away from children.

### Example 8—Echinacea

Each 1 ml contains Echinacea root (Echinacea augustifolia) equivalent to 500 mg dried herb mixed in water to make up the volume. Further ingredients may be added to facilitate the dissolution of one this ingredient. Store at room temperature between 15-30 degrees away from light and moisture. Do not store in the bathroom. Keep away from children.

### Example 9—Diet Assist

Each 1 mL contains the following ingredients mixed in water made up to the volume. Further ingredients may be added to facilitate the dissolution of one or more of these ingredients.

| Ingredient | Amount | |
|---|---|---|
| Vitamin B1 as thiamine hydrochloride | 5 | mg |
| Vitamin B2 | 40 | mg |
| Vitamin B3 as nicotinamide | 8 | mg |
| Vitamin B5 as calcium pantothenate | 2 | mg |
| Vitamin B6 as pyroxidine hydrochloride | 5 | mg |
| Vitamin B12 | 100 | mcg |

Store at room temperature between 15-30 degrees away from light and moisture. Do not store in the bathroom. Keep away from children.

### Example 10—Healthy Boost

Each 1 mL contains the following ingredients mixed in water made up to the volume. Further ingredients may be added to facilitate the dissolution of one or more of these ingredients.

| Ingredient | Amount | |
|---|---|---|
| Vitamin B1 | 50 | mg |
| Vitamin B2 | 50 | mg |
| Vitamin B3 | 75 | mg |
| Vitamin B5 as calcium d-pantothenate | 50 | mg |
| Vitamin B6 | 50 | mg |
| Vitamin B7 | 30 | mcg |
| Vitamin B9 as folic acid | 50 | mcg |
| Vitamin B12 | 50 | mcg |
| Magnesium aspartate | 20 | mg |
| Barley grass | 75 | mg |
| Bioflavonoid complex (50% flavanones) | 100 | mg |
| Chlorella (broken cell) | 75 | mg |
| Hops flower (Humulus lupulus) with 0.4% flavonoids | 50 | mg |
| Passion flower (Passiflora incarnate) herb | 25 | mg |
| Spirulina | 50 | mg |
| Inositol (hexaphosphate) | 50 | mg |

Store at room temperature between 15-30 degrees away from light and moisture. Do not store in the bathroom. Keep away from children.

### Example 11—Wake Up Extra Caffeine

Each 1 mL contains the following ingredients mixed in water made up to the volume. Further ingredients may be added to facilitate the dissolution of one or more of these ingredients.

| Ingredient | Amount | |
|---|---|---|
| Vitamin B1 as thiamine hydrochloride | 5 | mg |
| Vitamin B2 | 2 | mg |
| Vitamin B3 as nicotinamide | 8 | mg |
| Vitamin B5 as calcium pantothenate | 2 | mg |
| Vitamin B6 as pyroxidine hydrochloride | 5 | mg |
| Vitamin B7 | 20 | mcg |
| Vitamin B9 as folic acid | 150 | mcg |
| Vitamin B12 | 30 | mcg |
| Calcium phosphoate | 10 | mg |
| Magnesium phosphate | 10 | mg |
| Potassium phosphate monobasic | 5 | mg |
| Caffeine | 100 | mg |
| Inositol (hexaphosphate) | 50 | mg |

Store at room temperature between 15-30 degrees away from light and moisture. Do not store in the bathroom. Keep away from children.

It is envisaged that this formulation could be added to any food or beverage prior to consumption, but especially to any caffeine-containing beverage such as coffee to provide the consumer with additional caffeine.

### Example 12—Hangover Relief

Each 1 mL contains the following ingredients mixed in water made up to the volume. Further ingredients may be added to facilitate the dissolution of one or more of these ingredients.

| Ingredient | Amount | |
|---|---|---|
| Vitamin B1 as thiamine hydrochloride | 5 | mg |
| Vitamin B2 | 2 | mg |
| Vitamin B3 as nicotinamide | 8 | mg |
| Vitamin B5 as calcium pantothenate | 2 | mg |
| Vitamin B6 as pyroxidine hydrochloride | 100 | mg |
| Vitamin B7 | 20 | mcg |
| Vitamin B9 as folic acid | 150 | mcg |
| Vitamin B12 | 30 | mcg |
| Calcium phosphoate | 10 | mg |
| Magnesium phosphate | 10 | mg |
| Potassium phosphate monobasic | 5 | mg |
| Caffeine | 20 | mg |
| Inositol (hexaphosphate) | 50 | mg |

Store at, room temperature between 15-30 degrees away from light and moisture. Do not store in the bathroom. Keep away from children.

### Example 13—Mozzie Away

The value of vitamin B1 in the prevention and treatment of insect bites has been researched for over 50 years. Although the mechanism is still not clear, some trials (and numerous anecdotal reports) indicate that when a high dose of vitamin B1 (at least 100 mg for adults) is ingested, mosquitoes and other biting insects will either not land on the skin, or if they do they will not feed. In addition, vitamin B1 is known to have an anti-inflammatory effect. This means that high levels of vitamin B1 may assist in preventing insect bites from becoming too inflamed.

Each 1 ml contains 100 mg vitamin B1 (thiamine hydrochloride) mixed in water to make up to the volume. Further ingredients are added to facilitate the dissolution of this ingredient. Store at room temperature between 15-30 degrees away from light and moisture. Do not store in the bathroom. Keep away from children.

### Example 14—Children Multivitamin

Each 1 ml contains the following ingredients mixed in water and made up to the volume. Further ingredients may be added to facilitate the dissolution of one or more of these ingredients.

| Ingredient | Amount | |
|---|---|---|
| Vitamin B1 as thiamine nitrate | 50 | mcg |
| Vitamin B2 | 150 | mcg |
| Vitamin B3 as nicotinamide | 2 | mg |
| Vitamin B5 as calcium pantothenate | 0.5 | mg |
| Vitamin B6 as pyroxidine hydrochloride | 250 | mcg |
| Vitamin B12 | 30 | mcg |
| Folic acid | 50 | mcg |
| Biotin | 25 | mcg |
| Magnesium phosphate | 20 | mg |
| Manganese amino acid chelate (Manganese 12.5 mcg) | 25 | mcg |
| Calcium phosphate | 10 | mg |
| Potassium iodide | 75 | mcg |
| Ferrous fumarate | 3 | mg |
| Zinc oxide (Zinc 1 mg) | 0.5 | mg |

Store at room temperature between 15-30 degrees away from light and moisture. Do not store in the bathroom. Keep away from children.

### Heat and Long Term Storage Stability Trials

Example 15 describes both heat stability trials that were conducted to determine whether liquid formulations used in the present invention would be stable when added to hot foods or beverages, and long term storage stability trials that were conducted to determine whether liquid formulations used in the present invention could be stored for long period of time without significant degradation to the ingredients therein.

Heat was applied by different methods, including placing the solution in a test tube in a bath of hot water (80° C. or 100° C.) for 15 minutes, or by mixing a concentrated solution with hot water or hot coffee (80° C. or 100° C. for both) for an equivalent time. Long term stability studies were carried out by storing individual vitamin solutions at room temperature and at 4° C. for up to 4 months and sampling these solutions at various intervals. Degradation was assessed by the change in peak area of the HPLC peak specific to each particular compound.

The results showed that the reductions in vitamin concentrations due to heat degradation were less than 4% for any vitamin and any form of heat treatment. Solutions of vitamins B1,B3, B6, and B12 were stable over the entire 4 month period, when stored at room temperature or at 4° C. Other vitamins, including vitamins B2, B5, B7, and B9 exhibited varying levels of degradation over the 4 month period, when stored at either temperature.

### Example 15—Heat and Long Term Storage Stability Trials

### Materials and Methods

Reagents

Thiamine (B1), riboflavin (B2), niacinamide (B3), pyroxidine hydrochloride (B6), biotin (B7), folic acid (B9) and cyanocobalamin (B12) were purchased from Sigma-Aldrich Pty Ltd and calcium (+)-pantothenate (B5) was purchased from Novachem Pty Ltd (Wako). Test beverages were prepared with Vittoria Espresso ground coffee in a Sunbeam Café Crema machine. Water was Milli-Q grade.

Standard Solutions

Standard solutions were prepared by dissolving vitamins in Milli-Q water, with vortexing and sonication as required, at concentrations shown in the table below. All solutions were freshly prepared.

| Vitamin | Concentration | | Aq. solubility | |
|---|---|---|---|---|
| B1 | 75 | mg/mL | 500 | mg/mL |
| B2 | 85 | μg/mL | 85 | μg/mL |
| B3 | 100 | mg/mL | 500 | mg/mL |
| B5 | 75 | mg/mL | 1000 | mg/mL |
| B6 | 25 | mg/mL | 220 | mg/mL |
| B7 | 20 | μg/mL | 220 | μg/mL |
| B9 | 1.5 | μg/mL | 1.6 | μg/mL |
| B12 | 100 | μg/mL | 12.5 | μg/mL |

Instruments

All HPLC analyses were performed on a Shimadzu UFLC system (including LC-20AD pumps, SIL-20A HI autosampler and SPD-20A UV detector).

Chromatographic conditions for vitamins B1, B2, B3, B6, B9 and B12

Column: HCT- C18 (Agilent), 4.6*150 mm

Column temperature: 30° C.

Mobile phase: A—water+0.1% formic acid +0.05%TEA: B—25% ACN+75% methanol

Flow rate: 0.8 mL/min

Detection wavelength: 280 nm

Internal standard: caffeine

HPLC gradients for vitamins B1, B2, B3, B6, B9 and B12 are shown in the table below.

| Time (min) | % of B |
|---|---|
| 0 | 0 |
| 3 | 0 |
| 5 | 30 |
| 12 | 30 |

Injection volume for vitamins B1, B2, B3, B6, B9 and B12 are shown in the table below.

| Vitamin | Injection volume (μL) |
|---|---|
| B1 | 15 |
| B2 | 20 |
| B3 | 15 |
| B6 | 15 |
| B9 | 50 |
| B12 | 20 |

Chromatographic conditions for vitamins B5 and B7

Column: HCT-C18 (Agilent), 4.6*150 mm

Column temperature: 30° C.

Mobile phase: A—water+0.1% formic acid: B—acetonitrile

Flow rate: 1 mL/min

Detection wavelength: 210 nm

Internal standard: caffeine

HPLC gradients for vitamins B5 and B7 are demonstrated in the table below.

| Time (min) | % of B |
|---|---|
| 0 | 0 |
| 10 | 30 |

Injection volume for vitamins B5 and B7 are shown in the table below.

| Vitamin | Injection volume (μL) |
|---|---|
| B5 | 15 |
| B7 | 100 |

Heat Stability Studies

Sample Preparation

Vitamins were divided into two groups, depending on their solubility. “High concentration” vitamins were sufficiently soluble to be detected by the. HPLC analysis after 1/250 dilution. “Low concentration” vitamins were not sufficiently soluble and could not be detected after 1/250 dilution and therefore a different procedure was adopted for these compounds as described below.

High concentration vitamin (B1, B3, B5, B6) solutions

Solutions were prepared immediately before use in duplicate, using four different methods, described below:

a. Dilute 1 mL of each standard solution to 250 mL with Milli-Q water at room temperature (control sample)

b. Add 5 mL of each solution to separate 10 mL Falcon tubes and stand the tubes in hot water (80° C. or 100° C.) for 15 minutes. Then take a 1 mL sample from each tube and dilute to 250 mL with Milli-Q water at room temperature.

c. Dilute 1 mL of each solution to 250 mL with hot water (80° C. or 100° C.). Leave for 15 minutes, then take a sample and cool immediately to room temperature.

d. Dilute 1 mL of each solution to 250 mL with hot coffee (80° C. or 100° C.). Leave for 15 minutes, then take a sample and cool immediately to room temperature.

Low Concentration Vitamin (B2, B7, B9, B12) Solutions

Standard solutions were freshly prepared with Milli-Q water as described above. The test solutions below were then immediately prepared in duplicate:

a. Use undiluted (control sample)

b. Add 5 mL of each solution to separate 10 mL Falcon tubes and stand the tubes in hot water (80° C. or 100° C.) for 15 minutes, then cool immediately to room temperature.

Long Term Storage Stability Studies

Sample Preparation

Vitamin solutions were prepared as for the Heat Stability Studies.

Replicate aliquots of these solutions were placed in four 15 mL Falcon tubes. Two of these tubes were stored on a shelf at room temperature (RT) in the laboratory and two in the cold room (4° C.).

At 0, 0.5, 1, 1.5, 2, 3.5, and 4 months, samples were taken from each vial for

HPLC analysis. The high concentration vitamin samples (vitamins BI, B3, B5, and B6) were diluted to 1:250 with Milli-Q water before injection and the low concentration vitamin samples (vitamins B2, B7, B9, and B12) were injected undiluted.

Sample Analysis

Samples from each of the duplicate solutions described above were injected onto the HPLC in duplicate. HPLC conditions were as described above.

Data Analysis

Duplicate injections of the two samples were made and the mean of the four results was reported.

The percentage change in individual vitamin concentrations relative to the control sample was calculated as: 100×(Aₜₑₛₜ−A_{control})/A_{control}, where Aₜₑₛₜ and A_{control} are peak area ratios (analyte/intemal standard) for the test and control solutions respectively.

For the heat stability studies, statistical analysis was performed by Students t-test. For the storage stability studies, statistical analysis was performed by univariate ANOVA (General Linear Model). All statistical analyses were performed with SPSS 16.

### Results

Heat Stability Studies

High Concentration Vitamins

Results for high concentration vitamin solutions after heating to 80° C. are shown in the table below.

| | | % | | |
|---|---|---|---|---|
| Vitamin | Matrix | CV (control) | % Deviation | P value |
| B1 (Thiamine•HCl) | control | 0.01 | | |
| | heated | | 0.33 | 0.37 |
| | hot water | | −0.04 | 0.95 |
| | coffee | | 0.46 | 0.41 |
| B3 (Niacinamide) | control | 0.02 | | |
| | heated | | −0.24 | 0.66 |
| | hot water | | 0.33 | 0.34 |
| | coffee | | −3.72 | 0.02 |
| B5 (Ca Pantothenate) | control | 0.01 | | |
| | heated | | −2.78 | 0.02 |
| | hot water | | −0.77 | 0.51 |
| | coffee | | 1.78 | 0.93 |
| B6 (Pyridoxal HCl) | control | 0.02 | | |
| | heated | | 0.05 | 0.71 |
| | hot water | | 1.39 | 0.28 |
| | coffee | | −0.63 | 0.91 |

Results for high concentration vitamin solutions after heating to 100° C. are shown in the table below.

| | | % | | |
|---|---|---|---|---|
| Vitamin | Matrix | CV (control) | % Deviation | P value |
| B1 (Thiamine•HCl) | control | 0.01 | | |
| | heated | | 0.22 | 0.54 |
| | hot water | | −0.26 | 0.55 |
| | coffee | | 0.58 | 0.26 |
| B3 (Niacinamide) | control | 0.02 | | |
| | heated | | −0.86 | 0.86 |
| | hot water | | 0.4 | 0.32 |
| | coffee | | −3.62 | 0.03 |
| B5 (Ca Pantothenate) | control | 0.01 | | |
| | heated | | −2.27 | 0.005 |
| | hot water | | −1.15 | 0.23 |
| | coffee | | 0.31 | 0.43 |
| B6 (Pyridoxal HCl) | control | 0.02 | | |
| | heated | | −0.28 | 0.91 |
| | hot water | | 1.64 | 0.21 |
| | coffee | | −1.47 | 0.47 |

Low Concentration Vitamins

Results for low concentration vitamin solutions after heating to 80° C. are shown in the table below.

| Vitamin | % CV (control) | % Deviation | P value |
|---|---|---|---|
| B2 (Riboflavin) | 0.04 | 1.5 | 0.48 |
| B7 (Biotin) | 0.01 | −0.47 | 0.63 |
| B9 (Folic acid) | 0.02 | −1.92 | 0.05 |
| B12 (Cyanocobalamin) | 0.01 | −0.14 | 0.73 |

Results for low concentration vitamin solutions after heating to 100° C. are shown in the table below.

| Vitamin | % CV (control) | % Deviation | P value |
|---|---|---|---|
| B2 (Riboflavin) | 0.04 | 2.85 | 0.27 |
| B7 (Biotin) | 0.01 | −1.89 | 0.74 |
| B9 (Folic acid) | 0.02 | −2.26 | 0.04 |
| B12 (Cyanocobalamin) | 0.01 | −0.18 | 0.88 |

Summary: Heat Stability

Effect of Heating Solutions

High concentration vitamins: With heating to either 80° C. or 100° C. for 15 minutes, concentrations of vitamins B1, B3 and B6 were not affected. Minor, but statistically significant, degradation of vitamin B5 (calcium pantothenate) occurred at both 80° C. (−2.8%, P=0.02) and 100° C. (−2.3%, P=0.005).

Low concentration vitamins: Concentrations of vitamins B2, B7 and B12 were not significantly affected by heating to either 80° C. or 100° C. for 15 minutes. Vitamin B9 (folic acid) showed minor but statistically significant degradation on heating to 80° C. (−1.9%, P=0.05) and 100° C. (−2.3%, P=0.04).

Effect of Dilution with Hot Water and Coffee

Minor but statistically significant degradation of vitamin B3 (niacinamide) was apparent on dilution with coffee at both 80° C. (−3.7%, P=0.02) and 100° C. (−3.6%, P=0.03). Concentrations of other vitamins (B1, B5, B6) were unaffected by dilution with hot water or hot coffee.

Long Term Storage Stability Studies

Percentage Changes and Statistical Analysis

Percentage changes in analyte/internal standard area ratios (proportional to vitamin concentrations) after storage at RT and at 4° C. for up to 4 months were measured, and statistically analysed. The results are shown in the following table.

| | Time to achieve | | |
|---|---|---|---|
| | significant falls | | |
| Vitamin | at RT | at 4° C. | Comment |
| B1 (Thiamine) | — | — | Stable for 4 months |
| B2 (Riboflavin) | 2 weeks | 2 weeks | Falls sustained to |
| | (P = 0.000) | (P = 0.000) | 4 months |
| B3 (Niacinamide) | — | — | Stable for 4 months |
| B5 (Ca Pantothenate) | 1.5 months | 2 weeks | Falls sustained to |
| | (P = 0.014) | (P = 0.000) | 4 months, but <5% |
| | | | at all times |
| B6 (Pyroxidine•HCl) | — | — | Stable for 4 months |
| B7 (Biotin) | — | — | Stable for 4 months |
| B9 (Folic acid) | 2 weeks | 2 weeks | At RT, undetectable |
| | (P = 0.009) | (P = 0.005) | after 2 weeks. At |
| | | | 4° C., significant |
| | | | change only at |
| | | | 2 weeks. |
| B12 (Cyanocobalamin) | — | — | |

Summary: Long Term Storage Stability

Vitamins B1, B3, B6, B7 and B12 suffered no statistically significant degradation at either RT or 4° C. over the entire 4 month storage period.

Vitamin B2 was significantly degraded after 2 weeks (by 24.7 and 33.6% at RT and 4° C. respectively. However, little further degradation occurred in the subsequent period up to 4 months.

Vitamin B5 was significantly degraded after 1.5 months and 2 weeks at RT and 4° C. respectively and the falls were sustained for the remaining test period to 4 months. However, although statistically significant, the degradation was less than 4% at any time for either temperature.

At RT, vitamin B9 was significantly degraded after 2 weeks (by 10.0%) and was undetectable at all subsequent sampling times to 4 months. At 4° C., vitamin B9 was significantly degraded by 2 weeks (by 8.0%). At 1 month, levels had fallen by a further 5.7%, although the differences from basal levels at this time and all subsequent sampling times were not statistically significant.

Overall Summary: Heat & Storage studies

A summary of the vitamin degradation due to heating and long term storage is shown in the table below.

| | Heat | Heat | Water | Water | Coffee | Coffee | Storage | Storage |
|---|---|---|---|---|---|---|---|---|
| Vitamin | 80° C. | 100° C. | 80° C. | 100° C. | 80° C. | 100° C. | RT | 4° C. |
| B1 | †† | †† | †† | †† | †† | †† | † −2.4% | † −2.8% |
| B2 | †† | †† | nt | nt | nt | nt | −24.7% * | −33.6% * |
| B3 | †† | †† | †† | †† | −3.7% * | −3.6% * | † −1.8% | † −1.1% |
| B5 | −2.8% * | −2.3% * | †† | †† | †† | †† | −3.3% * | −3.9% * |
| B6 | †† | †† | †† | †† | †† | †† | † −1.5% | † −2.5% |
| B7 | †† | †† | nt | nt | nt | nt | −15.9% ‡ | −27.4% ‡ |
| B9 | −1.9% * | −2.3% * | nt | nt | nt | nt | −100.0% * | −13.7% * |
| B12 | †† | †† | nt | nt | nt | nt | † −1.2% | † −1.4% |

†† refers to non-significant reductions in vitamin concentrations of <2% in response to heat treatment
† refers to non-significant reductions in vitamin concentrations in response to long term storage (shown with greatest percentage change recorded over the 4 month testing period)
* refers to significant reductions in vitamin concentrations in response to heat treatment and long term storage. For the long term storage data, the percentage change shown is the greatest reduction recorded over the 4 month testing period.
‡ refers to transient reductions in vitamin B7 concentrations at 2 weeks, which recovered at all subsequent testing times over the 4 month period.
nt means not tested.

The reductions in vitamin concentrations due to heat degradation were less than 4% for any vitamin and any form of heat treatment. With the exceptions below, these reductions were generally not statistically significant.

Statistically significant reductions occurred for i) vitamin B5 and B9 solutions heated to 80° C. or 100° C. and ii) vitamin B3 solutions diluted with hot coffee (but not water) at 80° C. or 100° C.

With long term storage, solutions of vitamins B1, B3, B6, and B12 were stable over the entire 4 month period, when stored at RT or 4° C.

Vitamin B5 suffered significant degradation on storage at RT or 4° C., but the degradation was less than 4% for either temperature over the entire 4 month test period.

Vitamin B7 showed transient reductions after 2 weeks of storage at RT or 4° C., but levels returned to approach control levels at later times.

Significant degradation.of vitamins B2 and B9 occurred by 2 weeks of storage at RT or 4° C., with complete elimination of vitamin B9 by 1 month of storage at RT. Storage of vitamin B9 at 4° C. limited the maximum degradation to 13.7%.

### Conclusion

From the heat stability test results, it can be concluded that all vitamins tested are suitable for addition to hot liquids. As such, formulations containing the vitamins tested can be used in hot foods or beverages in accordance with the present invention without degradation of the vitamins, thus ensuring the desired nutritional benefit to the consumer is achieved.

Solutions containing vitamins B1, B3, B5, B6, and B12 can be stored for at least 4 months at room temperature. Vitamins B2, B7, or B9 within solution may degrade significantly on storage at room temperature or in refrigerated conditions in certain circumstances (e.g. when water is the solvent). One skilled in the art should take this into account when preparing formulations for use in accordance with the present invention.

### Focus Group

A focus group study is a qualitative research tool, the purpose in this instance being to gauge consumer reaction.

This focus group study was conducted to investigate (among other things) whether creating a link in the consumer's mind between an existing routine that they already carry out and taking their medicinal or nutritional supplements would be likely to improve compliance, particularly where that routine involves a food or a beverage, and the supplements can be added to the food or beverage for ingestion at the same time.

The routine selected for this study was a daily cup of coffee.

The worldwide coffee market is a large market, with an estimated 1.5 billion cups of coffee being consumed in cafes, restaurants and other retail outlets each year, and this amount is increasing. The “at home” coffee market is also growing. The coffee market is competitive, with evidence of a growing sophistication of brand-loyal consumers. There are therefore many people for which a daily cup of coffee is a routine they follow.

The results of the study demonstrated that improved compliance is likely when embodiments of the present invention are used in conjunction with a routine.

### Example 16—Focus Group

### Materials and Methods

A consumer research company was commissioned to conduct this focus group study. This type of study brings together groups of 6-7 people (participants) who have not previously met. They are then guided by a moderator through a discussion about the specified topic. Participants are encouraged to provide spontaneous feedback to both questions from the moderator and opinions provided by other members of the group.

The moderator's primary responsibility is to ensure full participation, negate domination by one or more participants, and understand the reasons behind their opinions. Often participants are not aware of the beliefs that cause them to act in a certain way until they have discussed them with others. Taking part in a discussion about a topic and hearing other participants ideas causes participants to think about their beliefs and what motivates them. It also provides an environment where relevant issues which the researchers may not have considered can arise. In the context of improving compliance, this is particularly true. The group dynamics and interaction of participants reveal much about attitudes, beliefs and priorities that exist amongst the group, and bearing in mind that the group is selected to be representative of a consumer group, the results of the study can be used to evaluate the likely effect in the “real world”.

In this case, two groups of participants were recruited for this study. Group 1 consisted of females aged 20-35 years old who are regular coffee drinkers. Group 2 consisted of males aged 20-35 years old who are regular coffee drinkers. Regular coffee drinkers are considered to be those who consume coffee 1-3 times each day. The participants in each group were a mix of those who consume coffee “indoors” (i.e. home, office, etc) and those who consumer coffee “outdoors” (i.e. café, restaurant, etc).

The discussion of each focus group lasted for approximately 1 hour, consisting of three stages as follows:

Stage 1 involved an explanation of some embodiments of the invention from the moderator to the group, including the concept of a “product” being a single-use container comprising a formulation for ingestion that has health benefits, a proposed or envisaged use of the product being dispensing the formulation into coffee, and ingesting the coffee containing the formulation. Also discussed was the concept of taking the formulation at a retail outlet or at home, and on a regular or occasional basis. Other related concepts and matters were also discussed. The participants responses and other comments were noted.

Stage 2 was a taste test, followed by discussion of the participants' reactions to the taste test and further discussion (with more details provided by the moderator) of the product. For the taste test, each participant was provided with a freshly brewed cup of coffee of the participant's preference (e.g. cappuccino, long black, etc) to which was added 1 mL of formulation with the following nutritional supplements:

| Vitamin | Concentration | |
|---|---|---|
| B1 | 75 | mg/mL |
| B2 | 85 | μg/mL |
| B3 | 100 | mg/mL |
| B5 | 75 | mg/mL |
| B6 | 25 | mg/mL |
| B7 | 20 | μg/mL |
| B9 | 1.5 | μg/mL |
| B12 | 100 | μg/mL |

Stage 3 was then a discussion of pricing and proposed brand names, and is not discussed further herein.

Objectives were set for the study and included determining the reaction of each participant/group in terms of: newness and uniqueness in the market; likes and dislikes; perceived need for the product; willingness to purchase the product; when to ingest; where to ingest; and the type of people who would ingest the formulation.

### Results

Results from the discussions (including audio/video recordings and the moderators' notes) were analysed. Some of the findings are as follows:
the stage 1 initial reactions to the product were mixed, there was interest in the health benefits, but there were also concerns regarding taste, contents, effectiveness and price and it seemed participants would like more information;
following a fuller explanation of the product, the ingredients, and their benefits, interest increased although some participants still had specific questions such as the specific supplements and dosage levels of each in a proposed product (in a final product sold commercially, these would obviously be provided with the product);
when provided with information on different proposed formulations, a formulation designed to be a “healthy boost” was the most well received but there was also interest in a “stress release” and “cold and flu” formulation, with some females also interested in an “executive B formulation”;
it was believed that the product was unique to the market;
once tasted there were “no concerns” about the product;
both “indoor” (i.e. home, office, etc) and “outdoor” (i.e. café, restaurant, etc) distribution channels were considered appropriate;
there was clear indications from some participants that this product would increase compliance, including a comment from the consumer research company that participants saw a “market for the product for those who would like to be taking a daily multivitamin but can't get into the habit”. Specific comments from participants included:

“ . . . if they were sold at [the local supermarket] and were comparable in price to your multivitamin then you might go: oh, I have a coffee every morning, that makes it easy to get into the routine of having a vitamin everyday . . . ” (male participant)

“ . . . I tried having multivitamins every day but I'd always forget. I don't forget my morning coffee! . . . ” (male participant)

“I've tried many times to try to have vitamins every day but I just forget. The convenience of this though would be really easy, you could see the sign at the coffee store and have it straight away” (female participant)

Accordingly, the results of the study demonstrated that improved compliance is likely when embodiments of the present invention are used in conjunction with a routine.

The disclosure of every patent, patent application, and publication cited herein is hereby incorporated herein by reference in its entirety.

The citation of any reference herein should not be construed as an admission that such reference is available as “Prior Art” to the instant application.

Throughout the specification the aim has been to describe specific embodiments of the invention without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the appended claims.

1. A single-use container comprising a reservoir that comprises a sterile liquid formulation, wherein the reservoir is in fluid communication with an outlet adapted to be opened in order to dispense the formulation in an aseptic manner, wherein the formulation is formulated for ingestion, and wherein the formulation consists essentially of a medicinal supplement and/or a nutritional supplement.

2-3. (canceled)

4. The container of claim 1, wherein the formulation consists essentially of a vitamin and/or a mineral and/or a herbal extract.

5. The container of claim 1, wherein the formulation comprises a bitter-tasting vitamin.

6. The container of claim 1, wherein the formulation is formulated for addition to a food or beverage prior to ingestion.

7-10. (canceled)

11. The container of claim 1, wherein the container comprises a frangible means located between the reservoir of the container and the outlet of the container, that permits opening of the container in order to dispense the formulation.

12-14. (canceled)

15. The container of claim 1, wherein the container dispenses a unit dosage of formulation.

16. The container of claim 1, wherein the container maintains a sterile environment for the formulation before dispensing.

17. The container of claim 1, wherein the container is produced by the blowfillseal process.

18. The container of claim 1, wherein the container is labeled to indicate that the container is to be used at a particular time.

19-24. (canceled)

25. A strip of single-use containers, comprising a plurality of single-use containers as defined in claim 1 connected to each other by attaching portions of adjacent containers to form a connected strip.

26. The strip of claim 25, wherein the containers are detachably connected.

27. The strip of claim 25 or 26, wherein the strip or each container in the strip is labeled to indicate when the containers are to be used.

28. (canceled)

29. A strip of single-use containers, the containers each comprising a reservoir that comprises a sterile liquid formulation, wherein each reservoir is in fluid communication with an outlet of each container adapted to be opened in order to dispense the formulation it holds in an aseptic manner, wherein the formulation in each container is formulated for ingestion, wherein the containers are connected by attaching portions of adjacent containers to form a connected strip, and wherein the strip or each container in the strip is labeled to indicate when the containers are to be used.

30. The strip of claim 29, wherein the containers are detachably connected.

31-32. (canceled)

33. The strip of claim 29, wherein the formulation in each container consists essentially of a medicinal supplement and/or a nutritional supplement.

34-35. (canceled)

36. The strip of claim 29, wherein the formulation in each container consists essentially of a vitamin and/or a mineral and/or a herbal extract.

37. The strip of claim 29, wherein the formulation in each container comprises a bitter-tasting vitamin.

38-46. (canceled)

47. The strip of claim 29, wherein each container dispenses a unit dosage of formulation.

48. The strip of claim 29, wherein each container maintains a sterile environment for the formulation before dispensing.

49. The strip of claim 29, wherein each container is produced by the blowfillseal process.

50. (canceled)

51. A compliance enhancing system comprising the container of claim 1 or the strip of claim 29, wherein the container or strip is labeled to indicate that the formulation of each container is to be ingested in conjunction with an existing routine.

52. The system of claim 51, wherein the container or strip is labeled to indicate that the formulation of each container is to be dispensed into a food or beverage that is taken as part of an existing routine.

53. The system of claim 51, wherein the existing routine is a daily routine.

54. (canceled)

55. A method of enhancing compliance in a consumer, the method comprising providing a consumer with the container of claim 1 or the strip of claim 29, wherein the container or strip is labeled to indicate that the formulation within the container or each container is to be added to a food or beverage that is taken as part of an existing routine, the consumer dispensing the formulation into a food or beverage that is taken as part of the existing routine, the consumer then ingesting the food or beverage containing the formulation.

56. A method of enhancing compliance in a consumer, the method comprising providing a consumer with the container of claim 1 or the strip of claim 29, wherein the container or strip is labeled to indicate that the formulation within the container or each container is to be added to a food or beverage that is taken as part of an existing routine, providing the consumer with the food or beverage, wherein the formulation is dispensed into the food or beverage.
